(19) United States
(12) Patent Application Publication
(10) Pub. No.: US 2016/0372995 A1
(43) Pub. Date: Dec. 22, 2016

(54) METHODS AND APPARATUS FOR INTEGRATED MACHINE SEGMENTATION

(71) Applicant: Boulder Wind Power, Inc., Louisville, CO (US)

(72) Inventors: James S. Smith, Lyons, CO (US); Swarnab BANERJEE, Broomfield, CO (US); Brian SULLIVAN, Boulder, CO (US); Stephane EISEN, Louisville, CO (US); Cameron REAGOR, Broomfield, CO (US)

(73) Assignee: Boulder Wind Power, Inc., Louisville, CO (US)

(21) Appl. No.: 15/253,170

(22) Filed: Aug. 31, 2016

Related U.S. Application Data
(63) Continuation of application No. PCT/US2015/019148, filed on Mar. 6, 2015.
(60) Provisional application No. 61/949,579, filed on Mar. 7, 2014.

(51) Int. Cl. H02K 21/12; H02K 11/04; H02K 7/18

(52) U.S. Cl. CPC H02K 21/12; H02K 7/183; H02K 11/044; H02K 11/046

(57) ABSTRACT

An apparatus includes a machine segment configured to be disposed in an electromagnetic machine. The electromagnetic machine has a moving body associated with power in the mechanical state and the machine segment is associated with a portion of a power of the electromagnetic machine. The machine segment includes a first portion and a second portion electrically connected to form a modular electrical circuit. The first portion includes a machine winding associated with power in an AC electrical state. The first portion and the moving body are collectively configured to convert power between the mechanical state and the AC electrical state. The second portion includes a converter that converts power between the AC electrical state and a DC electrical state. The second portion is configured to be electrically connected to an electrical circuit external to the machine segment, and transfer power in the DC state to and/or from the machine segment.

### CROSS-REFERENCE TO RELATED APPLICATIONS

This application claims priority to and is a continuation of PCT Application No. PCT/US2015/019148 titled “Methods and Apparatus for Integrated Machine Segmentation,” filed Mar. 6, 2015, which claims priority to and the benefit of U.S. Provisional Patent Application No. 61/949,579, filed Mar. 7, 2014, and titled “Methods and Apparatus for Integrated Direct Current Machine Segmentation,” each of which is incorporated herein by reference in its entirety.

### BACKGROUND

The embodiments described herein relate generally to systems and methods for converting power between a substantially mechanical state and a substantially direct current electrical state, and more particularly, to methods and apparatus for integrated direct current machine segmentation.

In some instances, electromagnetic machines include and/or are otherwise electrically coupled to a power converter that can be configured to convert electrical power between an alternating current (AC) state and a direct current (DC) state (or a first AC state and a second AC state, with an intermediate DC state therebetween). In some electrical utility grid-level applications such as, for example, some known wind power generators or the like, power converters can be used to convert a voltage having an alternating current associated with and/or generated by electromagnetic induction (e.g., generated by moving one or more magnets relative to a machine winding) to a voltage having an alternating current associated with the grid. In some such applications, there can be challenges in the design and/or implementation of the power converters and/or integration with a machine. For example, in some instances, power converters with a relatively high voltage rating are needed to convert the voltage. Moreover, in some instances, the configuration of the power converters can be such that portions of the electrical circuit coupled thereto are not modular, which in turn, can lead to a lack of flexibility in design and/or usage, as well as increased difficulty and/or cost in repairing faulty components.

Thus, a need exists for improved methods and apparatus for integrated direct current machine segmentation in, for example, electromagnetic machines.

### SUMMARY

Methods and apparatus for integrated direct current machine segmentation are described herein. In some embodiments, an apparatus includes a set of machine segments configured to be disposed in an electromagnetic machine. The machine is configured such that each machine segment from the set of machine segments share a moving body of the machine, such as, for instance, a shared rotor. Each machine segment from the set of machine segments includes a first portion and a second portion that are electrically connected to form a substantially modular electrical circuit. The first portion includes a machine winding having at least one conductor. The machine winding is configured to carry an alternating current along a length of the conductor. The machine winding is associated with power in a substantially AC electrical state. The machine winding and the shared moving body are collectively configured to convert between power in the substantially AC electrical state and power in a substantially mechanical state. The second portion includes a converter electrically coupled to the machine winding. The converter is configured to convert between power in the substantially AC electrical state associated with the alternating current and power in a substantially DC electrical state. A first machine segment from the set of machine segments is electrically connected to a second segment from the set of machine segments to form a combined DC power. The set of machine segments is configured to transfer the combined DC power between the set of machine segments and an external electrical circuit.

### BRIEF DESCRIPTION OF THE DRAWINGS

FIG. 1 is a schematic illustration of a machine segment according to an embodiment.

FIG. 2 is a cross-sectional illustration of a portion of an axial flux machine structure according to an embodiment.

FIGS. 3-11 are schematic illustrations of machine segments each according to a different embodiment.

FIG. 12 is a schematic illustration of at least a portion of a machine structure according to another embodiment.

FIG. 13 is a schematic illustration of at least a portion of a machine structure according to another embodiment.

FIGS. 14-18 are schematic illustrations of a machine arrangement including a number of machine segments each according to a different embodiment.

### DETAILED DESCRIPTION

In some embodiments, an apparatus includes a machine segment configured to be disposed in an electromagnetic machine. The machine is formed by a set of corresponding machine segments, and the set of corresponding machine segments share a moving body of the machine, such as a shared rotor. The shared moving body of the machine is associated with rotational and/or translational movement, and is further associated with a mechanical power (i.e., a rotation and a torque, and/or a translation and a force).

The machine segment includes a first portion and a second portion that are electrically connected to form a modular electrical circuit. The first portion includes a machine winding having at least one conductor. The machine winding is configured to carry an alternating current (AC) along a length of the conductor, and is associated with AC electrical power. The machine winding and the AC electrical power can be associated with one or more electrical phases. The machine winding and the shared moving body are collectively configured to convert between AC electrical power and mechanical power.

The second portion includes a converter electrically coupled to the machine winding. The converter is configured to convert electrical power between a first state a second state. For instance, in some embodiments the converter can convert between AC electrical power and direct current (DC) electrical power. The machine segment is configured to be electrically connected to an electrical circuit external to the machine segment, such that DC electrical power can be transferred to and/or from the external circuit. In other embodiments, the converter can convert between electrical power in a first AC state and electrical power in a second AC state, such that AC electrical power can be transferred to and/or from the external circuit.

In some embodiments the machine segment can receive DC electrical power from the external circuit, convert the DC electrical power to AC electrical power, and convert the AC electrical power to mechanical power, such that the machine segment operates as a motor. In some embodiments the machine segment can receive mechanical power from the shared moving body, convert the mechanical power to AC electrical power, and convert AC electrical power to DC electrical power, such that the machine segment operates as a generator. In various embodiments the machine segment can be configured to operate as a motor, configured to operate as a generator, or configured to operate as a motor at a first time and operate as a generator at a second time.

The first portion and the second portion can be configured as a modular unit, such that the machine segment can be removed both mechanically and electrically from the set of corresponding machine segments, and from the external circuit. In some embodiments, the first portion and the second portion can be configured to collectively form a single unitary assembly. In some other embodiments, the first portion can be removably coupled to the second portion, so that each portion can be individually installed, removed, and/or replaced. This manner of configuring a machine into modular units can improve design and operational flexibility of the machine, facilitate installation and replacement of smaller portions of the machine, and/or improve the robustness of the machine to various operational characteristics relating to either normal operation or fault conditions.

In some systems, machine segments sharing a common moving body of an electromagnetic machine can be electrically connected together to form a combined power. For instance, some embodiments can connect a DC terminal of a power converter from a first machine segment to a DC terminal of a power converter from a second machine segment, such that DC power is combined from the first machine segment and the second machine segment. The first machine segment can be connected electrically in series with the second machine segment, or the first machine segment can be connected electrically in parallel with the second machine segment. Other systems can have a set of machine segments, each sharing a common moving body of an electromagnetic machine. The set of machine segments can be electrically connected in series, electrically connected in parallel, or electrically connected by a combination of series and parallel connections, to form a combined power. Such systems, or any of the machine segments that form such systems, can be further augmented by the inclusion of such elements as electrical filters, control systems, protection devices, and/or heat rejection systems.

As used herein, the reference to “power in a substantially alternating current (AC) electrical state” generally refers to electrical power where voltage and current share a periodic waveform of a given frequency. The periodic waveform shape can be characterized by a sinusoidal wave, square wave, triangle wave, or any other shape where the voltage alternates in sign at a frequency, and the current alternates in sign at the frequency. Power in a substantially AC electrical state can be “real” power, as commonly referred to in the electrical arts, where the waveforms of voltage and current are substantially aligned, “imaginary” power, as commonly referred to in the electrical arts, where the waveforms of voltage and current are offset by an angular equivalent of 90 degrees, or any combination of real power and imaginary power. Power in a substantially AC electrical state need not be in a purely AC electrical state and can, for example, also contain other portions of power in a different state and still be power in a substantially AC electrical state. For example, while power in a substantially AC state is primarily in an AC electrical state, power in a substantially AC electrical state can contain power at other non-productive harmonic frequencies, including a DC component, and still be power in a substantially AC electrical state. Such power can also include resistive losses, eddy currents, circulating currents, electromagnetic interference, or any other form of power while still being characterized as power in a substantially AC electrical state.

As used herein, the reference to “power in a substantially direct current (DC) electrical state” generally refers to electrical power where voltage and current do not have a periodic component, and instead maintain a particular sign for a period of time. Power in a substantially DC electrical state need not be in a purely DC electrical state and can, for example, also contain other portions of power in a different state and still be power in a substantially DC electrical state. For example, while power in a substantially DC electrical state is primarily in a DC electrical state, power in a substantially DC electrical state can contain power in an AC state such as at a harmonic frequency or multiple harmonic frequencies, and still be power in a substantially DC electrical state. Such power can also include resistive losses, eddy currents, circulating currents, electromagnetic interference, or any other form of power while still being characterized as power in a substantially DC electrical state.

As used herein, the reference to “power in a substantially mechanical state” generally refers to the combination of a force and a linear velocity, and/or the combination of a torque and a rotational velocity, as is commonly defined by the mechanical arts. Power in a substantially mechanical state need not be in a purely mechanical state and can, for example, also contain other portions of power in a different state and still be power in a substantially mechanical state. For example, while power in a substantially mechanical state is primarily in a mechanical state, power in a substantially mechanical state can also contain thermal power (e.g., relating to friction losses, etc.), viscous or other fluid-related power, electrical/magnetic power (e.g., eddy currents, circulating currents, electromagnetic interference, etc.), or any other forms of power, while still being characterized as power in a substantially mechanical state.

As used in this specification, the singular forms “a,” “an” and “the” include plural referents unless the context clearly dictates otherwise. Thus, for example, the term “a segment” is intended to mean a single segment or a combination of segments, “a winding” is intended to mean one or more windings, or a combination thereof.

As used herein, the term “parallel” when used to describe two geometric constructions (e.g., two lines, two planes, a line and a plane or the like) generally refers to an arrangement in which the two geometric constructions are substantially non-intersecting as they extend substantially to infinity. For example, as used herein, when a planar surface (i.e., a two-dimensional surface) is said to be parallel to a line, every point along the line is spaced apart from the nearest portion of the surface by a substantially equal distance. Two geometric constructions are described herein as being “parallel” or “substantially parallel” to each other when they are nominally parallel to each other, such as for example, when they are parallel to each other within a tolerance (e.g., manufacturing tolerances, measurement tolerances, or the like). The term “parallel” when used to describe, for example, two or more electrically connected conductors generally refers to an arrangement in which the two or more conductors are electrically connected in a closed circuit such that an operating current is divided into each conductor before recombining to complete the electrical circuit. Similarly stated, the two or more conductors are considered to be combined in an electrically parallel configuration. Conductors that are electrically coupled in parallel can be, but are not necessarily, geometrically parallel. Similarly, geometrically parallel conductors can be, but are not necessarily, electrically coupled in parallel.

As used herein, the term “electrically isolated” generally describes a relationship between two conductors within an area, a volume, a segment, a module, and/or the like. Specifically, if a first conductor is electrically isolated from a second conductor within a given area, the first conductor does not intersect and/or is not otherwise electrically connected with the second conductor within that area. The first conductor can, however, intersect and/or be electrically connected to the second conductor outside the area. For example, two conductors can be electrically isolated from each other and/or non-intersecting within a winding region but electrically coupled to each other within a terminal region. Similarly, as used herein, the term “modular” generally describes an arrangement or relationship between two objects that can be, for example, selectively and/or removably coupled. By way of example, a first object defining an area, volume, and/or portion can be configured to be removably coupled (e.g., physically, electrically, fluidically, etc.) to a second object defining an area, volume, and/or portion that is independent of the area, volume, and/or portion of the first object, and as such, the first object and the second object can be said to have a “modular” arrangement. Thus, in a modular arrangement, a first object can be physically and electrically isolated from a second object prior to being coupled thereto and once coupled, the area, volume, and/or portion of the first object and the area, volume, and/or portion of the second object can be in physical and/or electrical contact.

The embodiments and methods described here can be used in various types of electromagnetic machines. By way of example, the embodiments and methods described herein can be used in permanent magnet machines such as, axial flux machines, radial flux machines, and/or transverse flux machines, in which a first component rotates about an axis or translates along an axis (e.g., in a single direction or in two directions) relative to a second component. Such machines typically include windings (e.g., disposed about an iron or otherwise ferromagnetic core, disposed about an air or otherwise non-ferromagnetic core, etched on a printed circuit board, and/or the like) to carry electric current through coils that interact with a magnetic flux from the magnets via a relative movement between the magnets and the windings. In some industrial applications (including the embodiments described herein), the permanent magnets are mounted on the first component (i.e., a rotor), configured to rotate about or translate along the axis and the windings are mounted on and/or included in the second component (i.e., a stator), maintained in a substantially fixed or stationary position. In other applications an alternating magnetic field can be provided by any means including electromagnetic induction, electromagnets, or any other suitable means. The windings of the machines can be associated with a power in a substantially alternating current (AC) electrical state, and the moving body of the machines can be associated with power in a substantially mechanical state (i.e. a the combination of a torque and a rotation, and/or the combination of a force and a translation). The windings of the machines and the moving body of the machines can be collectively configured such that the machines convert power between the substantially AC electrical state and the substantially mechanical state. In some instances, portions of the electromagnetic machines such as, for example, a stator and/or a rotor can be formed from any number of modular machine segments that, when physically and electrically arranged or coupled, form the stator or the rotor, respectively. In such instances, the modular machine segments can convert a portion of the overall machine power between a power in the substantially AC electrical state and a power in the substantially mechanical state.

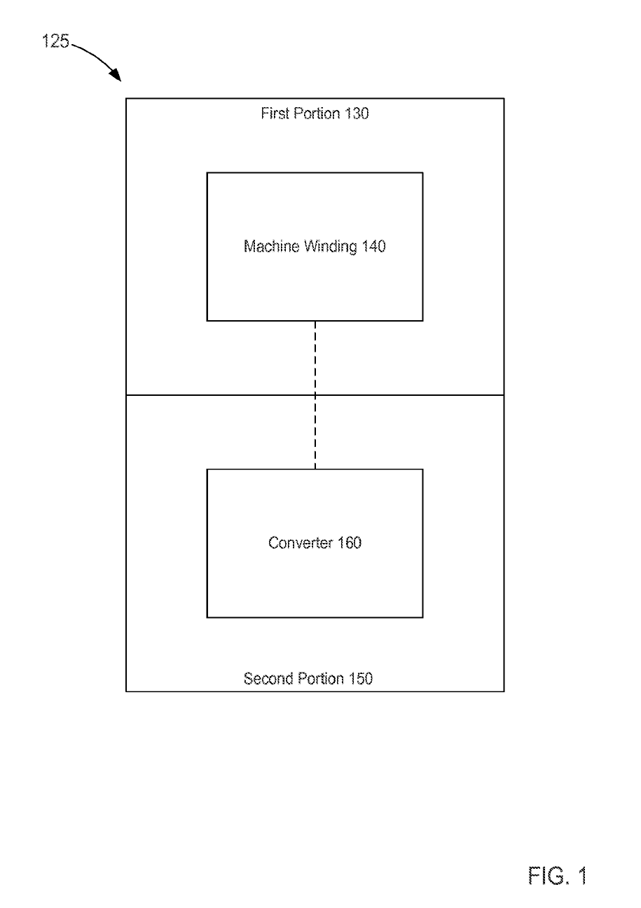

By way of example, FIG. 1 is a schematic illustration of a machine segment 125 according to an embodiment. The machine segment 125 can be, for example, substantially modular and can be configured to be physically and/or electrically coupled to one or more similar or corresponding machine segments (not shown in FIG. 1) to form a portion of an electromagnetic machine. For example, in some embodiments, the machine segment 125 can be a modular segment of a segmented stator or rotor included in an electromagnetic machine. In some embodiments, an electromagnetic machine can be configured in such a manner that each of the segments of a segmented portion of the electromagnetic machine share a moving body of the machine such as a rotor and/or rotor support structure moving in a rotational direction. In some embodiments, the shared moving body of the machine can move along at least one of a single axis or rotation, more than one axis of rotation, a single axis of translation, and/or more than one axis of translation. In some embodiments such as those described herein, the machine segment 125 is included in and/or forms a portion of a segmented stator assembly (not shown in FIG. 1).

By way of example, in some embodiments, the machine segment 125 can include a laminated composite assembly included in and/or otherwise forming an integrated circuit (IC), a printed circuit board (PCB), a PCB assembly, an application-specific integrated circuit (ASIC), or any other suitable electrical circuit structure. As such, the machine segment 125 (i.e., the laminated composite assembly) can include any number of conductive layers that are physically and electrically separated by a corresponding number of insulating layers. In some embodiments, the insulating layers can be formed from an insulating and/or dielectric material such as fiberglass, cotton, silicon, and/or the like that can be bound by any suitable resin material (e.g., epoxy or the like). Thus, the insulating layers can be, for example, dielectric layers and/or core layers that can physically and electrically separate the conductive layers. The conductive layers can be, for example, relatively thin conductive sheets that are disposed on at least one surface of an insulating layer (i.e., a core layer). For example, the conductive layer can be copper, silver, aluminum, gold, zinc, tin, tungsten, graphite, conductive polymer, and/or any other suitable conductive material. In this manner, the conductive sheet can be masked and the undesired portions of the conductive sheet can be etched away, thereby leaving a desired set of conductive traces. Moreover, the machine segment 125 can include any number of alternately stacked insulating layers and conductive layers and can include a set of electrical interconnects (e.g., vias, pressed pins, bus bars, terminals, etc.) that can selectively place the conductive layers in electrical contact. Thus, the machine segment 125 (i.e., the laminated composite assembly) can be configured to carry a current (e.g., associated with power distribution, a signal carrying information and/or induced by a magnetic source) along a length of the conductive traces as described in further detail herein. In some embodiments, the machine segment 125 can be similar, at least in part, to the laminated composite assemblies described in U.S. patent application Ser. No. 13/778,415, entitled “Methods and Apparatus for Optimizing Electrical Interconnects on Laminated Composite Assemblies,” filed on Feb. 27, 2013; U.S. patent application Ser. No. 13/799,998, entitled “Methods and Apparatus for Optimizing Structural Layout of Multi-Circuit Laminated Composite Assembly,” filed on Mar. 13, 2013; and/or U.S. patent application Ser. No. 13/829,123, entitled “Methods and Apparatus for Overlapping Windings,” filed Mar. 14, 2013, the disclosures of which are incorporated herein by reference in their entireties. In other embodiments, the arrangements and methods described herein can be applied to machine segments that include, for example, wire-wound coils and/or iron-core electromagnetic machines, where the wire-wound coils contain circuits electrically connected in series and/or parallel that form a conductive loop or winding.

As shown in FIG. 1, the machine segment 125 includes a first portion 130 and a second portion 150 that are electrically coupled to form at least a portion of an electrical circuit. The first portion 130 includes a machine winding 140 and the second portion 150 includes a converter 160. Although not shown in FIG. 1, in some embodiments, the machine winding 140 can be one or more conductive traces of a laminated composite assembly. For example, in some embodiments, the machine winding 140 can be a set of conductive traces that include a set of substantially parallel operable portions (e.g., linear portions in which current is configured to be induced by a magnetic field produced by a rotor or provided to create a magnetic field to cause movement of a rotor) and a set of end turns that are disposed in a substantially continuous and non-intersecting spiraled, helical, and/or concentric arrangement. Moreover, each conductive layer of the machine segment 125 includes a similarly arranged set of conductive traces, which are electrically connected to the conductive traces of the remaining conductive layers (e.g., by electrical interconnects such as vias). The arrangement of the first portion can be such that the machine winding 140 is associated with a single electrical phase. Thus, in some instances, a voltage associated with the electrical phase can be induced (e.g., by a movement of a magnet relative thereto, as described in further detail herein), for example, along a length of the operable portions, the voltage driving a current which is subsequently carried along the length of the machine winding 140 to a terminal portion, a connection portion, an output portion, an input portion, and/or the like. For example, in some embodiments, the machine winding 140 can include a terminal portion or the like (not shown in FIG. 1) that can be configured to electrically connect the machine winding 140 of the first portion 130 to the converter 160 of the second portion 150. In this manner, power in the substantially mechanical state from the shared moving body of the machine can be converted to a power in the substantially alternating current (AC) electrical state carried by the machine winding 140 and carried thereby to, for example, the converter 160 of the second portion 150, as described in further detail herein.

Although the machine winding 140 of the machine segment 125 shown in FIG. 1 can be associated with a single electrical phase having a single conductor associated with the electrical phase, in other embodiments, the machine winding 140 can include any number of electrical phases, and any number of conductors associated with each electrical phase. For example, in some embodiments, the machine winding 140 of the machine segment 125 can be associated with two electrical phases, three electrical phases, four electrical phases, five electrical phases, six electrical phases, nine electrical phases, or any other suitable number of electrical phases. Accordingly, the machine winding 140 of machine segment 125 can be formed by two conductors, three conductors, four conductors, five conductors, six conductors, nine conductors, or any other suitable number of conductors (respectively). Moreover, the arrangement of the machine winding 140 of machine segment 125 can be such that each conductor associated with an electrical phase can be electrically isolated from the remaining conductors associated with each of the other electrical phases. Therefore, when referring to the machine winding 140 it is to be understood that the machine winding 140 can be formed by a single-phase machine winding 140 or a multi-phase machine winding 140, as described in further detail herein.

As described above, the second portion 150 of the machine segment 125 includes a converter 160 (e.g., conversion circuit and/or the like). The first portion 130 and the second portion 150 of the machine segment 125 can be monolithically and/or unitarily formed such that the machine winding 140 is electrically connected to the converter 160, and substantially share a suitable form of mechanical support. For example, in some embodiments, the machine segment 125 can be a laminated composite assembly and/or the like that includes the first portion 130 and the second portion 150. In some embodiments, the machine winding 140 can include a terminal portion or the like that can be electrically coupled to a corresponding terminal portion of the converter 160. Thus, the machine segment 125 can be a substantially modular machine segment 125 or the like. In some embodiments, the first portion 130 and the second portion 150 can be both electrically and mechanically removably coupled, so that the first portion 130 can be independently assembled and/or removed from the second portion 150, and/or the second portion 150 can be independently assembled and/or removed from the first portion 130.

The converter 160 included in the second portion 150 can include any circuit that converts electrical power from a first state to a second state. For example, in some instances, electrical power having a first state (e.g., phase, frequency, voltage, current, and/or the like) can be carried by or on the machine winding 140 to the converter 160, which can convert the electrical power into an electrical power having a second state (e.g., phase, frequency, voltage, current, and/or the like, respectively) from one side of the converter 160 to the other side of the converter 160. For example, a current can flow from the machine winding 140 through the converter 160 to a load external to the machine segment 125 (not shown in FIG. 1). In some embodiments, the converter 160 can, for example, convert power in a substantially AC electrical state received from the machine winding 140 to power in a substantially direct current (DC) electrical state, which is then delivered to an external electrical circuit having an electrical load. In other embodiments, the converter 160 can, for example, convert power in a first substantially AC electrical state received from the machine winding 140 having a first set of characteristics to power in a substantially DC electrical state, and then convert the power in the substantially DC electrical state to, for instance, power in a second substantially AC electrical state having a second set of characteristics, which in some instances, are suitable for the load or other external electrical circuit (e.g., a power grid and/or the like). In some embodiments, the converter 160 can receive power (i.e., electric power) with a first set of characteristics from an external electrical circuit, and can convert the power to a second set of characteristics related to the machine winding 140. For example, the converter 160 can convert power received in a substantially DC electrical state from an external electrical circuit or a source circuit to power in a substantially AC electrical state with characteristics suitable to operate the machine segment 125 as a motor, such that the power in the substantially DC electrical state from the external circuit or the source circuit is converted into power in the substantially mechanical state in the shared moving body of the machine.

Although not shown in FIG. 1, the machine winding 140 can be electrically coupled to the converter 160 in any suitable manner. For example, in some embodiments, the machine winding 140 can be a single-phase machine winding 140, and include a positive terminal and a negative terminal (or the like) that are electrically connected to a corresponding positive terminal and negative terminal, respectively, of the converter 160. In some other embodiments, the first portion 130 can include a multi-phase machine winding 140, with separate positive terminals that are each associated with a different electrical phase and separate negative terminals that are each associated with a different electrical phase. In such embodiments, each of the electrical phases of the machine winding 140 can be electrically coupled to a different converter 160 or the same converter 160. For example, in some embodiments, a multi-phase machine winding 140 can be electrically coupled to the same converter 160 in such a manner that the positive and negative terminal portions of each of the electrical phases of the machine winding 140 are electrically connected to a corresponding positive and negative terminal of the converter 160. In other embodiments, the positive terminal portions of each electrical phase of the multi-phase machine winding 140 or the negative terminal portions of each electrical phase of the multi-phase machine winding 140 can be connected in, for example, a star or wye configuration and the remaining terminal portion of each of the electrical phases of the phases of the machine winding 140 can be electrically coupled to the converter 160. In other embodiments, the positive and negative terminal portions of each of the electrical phases of the machine winding 140 can be connected in, for example, a delta configuration with a set of terminals or lead that are configured to be electrically coupled to the converter 160. In some embodiments, the machine segment 125 can include any suitable passive and/or active device or circuit (e.g., a protection element, a filter element, a control device, a heat rejection device, etc.) that can be electrically connected to the machine winding 140 and/or the converter 160 or that can be electrically connected between the machine winding 140 and the converter 160 (i.e., in series), as described in further detail herein.

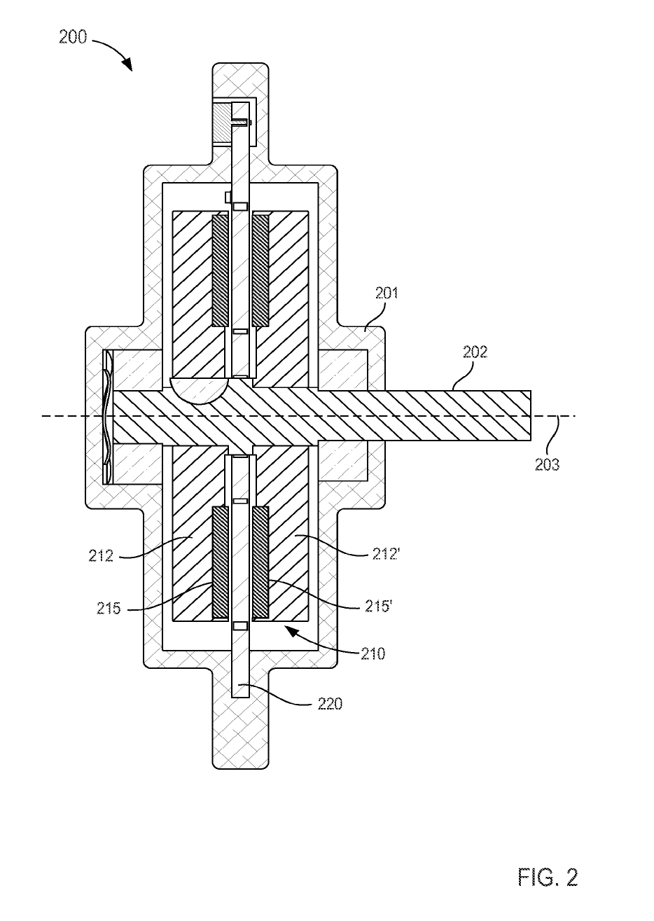

As described above, any of the embodiments described herein can be included in an electromagnetic machine such as, for example, an axial flux, radial flux, transverse flux, linear, or any other electromagnetic machine configuration. For example, the machine segment 125 can be included in and/or can form a portion of a segmented stator, rotor, or the like included in an axial flux electromagnetic machine that can be operated as a motor and/or a generator. The machine segment 125 can also be included in and/or can form a portion of a segmented stator, rotor, or the like included in an axial flux electromagnetic machine, where the machine segment 125 can individually be operated as a motor and/or a generator, separately from the corresponding machine segments. For example, FIG. 2 is a cross-sectional illustration of an axial flux machine structure 200 according to an embodiment. In some embodiments, the machine structure 200 can be included in a relatively large electromagnetic machine such as, for example, those found in wind power generators. In other embodiments, the machine structure 200 can be used in other types of electromagnetic machines and mechanisms such as, for example, other types of generators and/or motors.

The machine structure 200 can include a housing 201, a rotor assembly 210, and an annular stator assembly 220. The housing 201 substantially encloses the rotor assembly 210 and the stator assembly 220. The stator assembly 220 can be coupled to the housing 201 such that the stator assembly 220 remains in a substantially fixed position within the housing 201. The stator assembly 220 can include or support, for example, an air core type stator having a set of conductive windings (e.g., such as the machine winding 140 of FIG. 1). Furthermore the stator assembly 220 can be segmented to include any number of stator portions or segments (e.g., such as the machine segment 125 of FIG. 1). In some embodiments, the stator portions or segments can be substantially similar to stator portions or segments described in U.S. Patent Application Publication No. 2014/0049130 entitled, “Segmented Stator for an Axial Field Device,” filed Jan. 15, 2010, the disclosure of which is incorporated herein by reference in its entirety. Each stator segment can include at least one laminated composite assembly (e.g., at least one PCB) with one or more electrical circuits including one or more stator windings (i.e., machine windings). In some embodiments, the laminated composite assemblies can be similar to those described in U.S. Pat. No. 7,109,625 entitled, “Conductor Optimized Axial Field Rotary Energy Device,” filed Feb. 5, 2004, the disclosure of which is incorporated herein by reference in its entirety. In some embodiments, each stator segment (e.g., formed by a laminated composite assembly) can include at least one stator or machine winding (e.g., included in a first portion) and a power conversion electrical circuit (e.g., included in a second portion). In this manner, each stator segment can be, for example, a modular stator segment that can be physically and electrically coupled together to form the annular segmented stator 220.

The rotor assembly 210 can include multiple rotor elements, portions, and/or segments that can be coupled together to form the rotor assembly 210. For example, in some embodiments, the rotor assembly 210 can include rotor portions 212 and 212′ similar to those described in U.S. patent application Ser. No. 13/568,791 entitled, “Devices and Methods for Magnetic Pole and Back Iron Retention in Electromagnetic Machines,” filed Aug. 7, 2012, and/or U.S. patent application Ser. No. 13/152,164 entitled, “Systems and Methods for Improved Direct Drive Generators,” filed Jun. 2, 2011, the disclosures of which are incorporated herein by reference in their entireties. The rotor assembly 210 is coupled to a drive shaft 202 that is rotatably disposed within the housing 201. Therefore, the drive shaft 202 can be rotated about an axis 203 (e.g., either directly or indirectly by a mechanical force) and, with the rotor assembly 210 coupled to the drive shaft 202, the rotor assembly 210 is rotated with the drive shaft 202. Thus, the rotor assembly 210 can rotate relative to the stator assembly 220.

The rotor assembly 210 supports and/or is coupled to a set of magnetic assemblies (e.g., the rotor portion 212 is coupled to a magnet assembly 215 and the rotor portion 212′ is coupled to a magnet assembly 215′). In some embodiments, the magnetic assemblies 215 and 215′ can be similar to those described in U.S. patent application Ser. No. 13/692,083 entitled, “Devices and Methods for Magnet Pole Retention in Permanent Magnet Machines,” filed Dec. 3, 2012; U.S. Pat. No. 8,400,038 entitled, “Flux Focusing Arrangement for Permanent Magnets, Methods of Fabricating Such Arrangements, and Machines Including Such Arrangements,” filed Apr. 2, 2012; and U.S. Pat. No. 8,397,369 entitled, “Flux Focusing Arrangement for Permanent Magnets, Methods of Fabricating Such Arrangements, and Machines Including Such Arrangements,” filed Apr. 3, 2012. In this manner, as the rotor assembly 210 is rotated relative to the stator assembly 220, a magnetic flux flows between the poles of the magnetic assemblies 215 and 215′. Thus, an electric field is induced in or on the conductive windings (i.e., machine windings) of the stator assembly 220 that when properly gathered and delivered allows the machine structure 200 to behave as a generator or alternator. Conversely, an application of an electrical current to the conductive material of the stator assembly 220 produces Lorentz forces between the flowing current and the magnetic field of the magnetic assemblies 215 and 215′. The resultant force is a torque that rotates rotor assembly 210. Thus, the drive shaft 202 is rotated thereby doing work. In this manner, the machine structure 200 can behave as a motor or actuator. Although the rotor assembly 210 is described above as being coupled to the magnet assemblies 215 and 215′ and the stator assembly 220 is described above as including the stator windings (e.g., machine windings), in other embodiments, the rotor assembly 210 can include rotor windings (e.g., machine windings) and the stator assembly 220 can include the magnet assemblies 215 and 215′. In other embodiments, a magnetic field can be provided by any suitable manner. In an induction machine, for instance, a suitable magnetic field can be generated by electromagnetic induction of a second set of windings as a result of current flowing through a first set of windings.

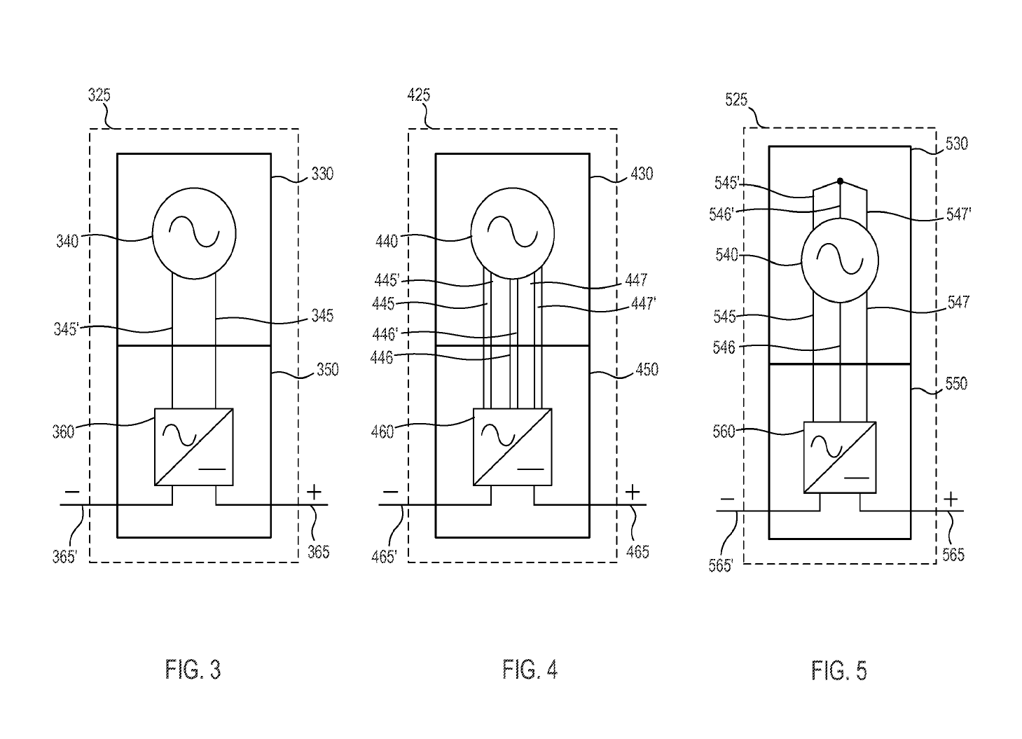

FIG. 3 is a schematic illustration of a machine segment 325 according to an embodiment. The machine segment 325 can be, for example, substantially modular and can be physically and/or electrically coupled to one or more similar or corresponding machine segments to form a portion of an electromagnetic machine. For example, the machine segment 325 can include and/or can otherwise be disposed in a housing or the like that can define, for example, a physical boundary and/or the like of the machine segment 325. In some embodiments, the machine segment 325 can be a modular segment of the segmented stator assembly 220 included in the machine structure 200 of FIG. 2.

In some embodiments, the machine segment 325 can be substantially similar in form and function as the machine segment 125 described above with reference to FIG. 1. For example, in some embodiments, the machine segment 325 can include a substantially modular stator segment formed by and/or otherwise including a laminated composite assembly, and a suitable electrical power converter, as described in detail above. Accordingly, such similar aspects of the machine segment 325 are generally discussed, yet not described in further detail herein. As shown in FIG. 3, the machine segment 325 includes a first portion 330 and a second portion 350 that are physically and electrically connected. Said another way, the first portion 330 and the second portion 350 can be physically and electrically connected and can form and/or can be disposed in the same housing or the like. In other embodiments, the first portion 330 and the second portion 350 can be electrically connected yet physically separate.

The first portion 330 includes a machine winding 340. The machine winding 340 can include, for example, a set of conductive stator windings or the like that can carry an electric current induced by a movement of one or more magnets relative thereto. More specifically, in some embodiments, as a rotor assembly is rotated and/or translated relative to the machine segment 325 (e.g., the machine segment is a modular segment of a segmented stator) and thus, the machine winding 340, a magnetic flux flows between the poles of magnetic assemblies coupled to the rotor assembly. Therefore, an electric field is induced that is associated with and/or otherwise produces an alternating current, which in turn is carried on or by the machine winding 340 of the machine segment 325. The alternating current carried on or by the machine winding 340 can have, for example, a magnitude, frequency, voltage, phase, and/or the like that is associated with the machine segment 325. That is to say, the alternating current resulting from the induced electric field can have a set of characteristics or the like that are dependent on and/or correspond to a set of characteristics associated with the movement of the magnet assemblies relative to the machine segment 325. In this way, the shared moving body of the machine can be associated with a power in the substantially mechanical state, the machine winding 340 can be associated with a power in substantially AC electrical state, and the shared moving body and the machine winding 340 can be collectively configured to convert power between the substantially mechanical state and the substantially AC electrical state.

In some embodiments, the machine winding 340 can be associated with a single electrical phase. In this manner, the machine winding 340 includes a first terminal 345 (e.g., a positive terminal) and a second terminal 345′ (e.g., a negative terminal) that can be electrically coupled to the second portion 350 such that an alternating current associated with the electrical phase can flow along the first terminal 345 and/or the second terminal 345′ to the second portion 340. For example, as shown in FIG. 3, the second portion 350 of the machine segment 325 includes a converter 360 that is electrically connected to the first terminal 345 and the second terminal 345′ of the machine winding 340. The converter 360 can include any circuit and/or device (e.g., AC buses, DC buses, mechanical switching devices, electrical switching devices, conductors, resistors, capacitors, inductors, etc.) that converts electrical power from a first state to a second state. For example, in some instances, electrical power (e.g., an induced electric field as described above) having a first state (e.g., phase, frequency, voltage, current, and/or the like) can be carried on or by the machine winding 340 to the converter 360, which can convert the electrical power into an electrical power having a second state (e.g., phase, frequency, voltage, current, and/or the like, respectively) from one side of the converter 360 to the other side of the converter 360. For example, the converter 360 can receive power in the substantially AC electrical state from the first terminal 345 and/or the second terminal 345′ of the machine winding 340 and can convert power in the substantially AC electrical state to power in the substantially DC electrical state. As shown in FIG. 3, the converter 360 includes a first terminal 365 (e.g., a positive terminal) and a second terminal 365′ (e.g., a negative terminal). The first terminal 365 and the second terminal 365′ can be configured to extend and/or can be electrically coupled to a terminal that can extend substantially beyond a boundary of the machine segment 325 (e.g., formed and/or defined by a housing, enclosure, electrical insulator, physical gap, and/or the like). In this manner, in some instances, the converter 360 can input and/or output power in the substantially DC electrical state with a voltage and/or the like that is associated with an external electrical circuit connected thereto (not shown in FIG. 3).

In other instances, the converter 360 can receive power in a first substantially AC electrical state having a first set of characteristics from the first terminal 345 and/or the second terminal 345′ of the machine winding 340 and can convert the power in the first substantially AC electrical state to a power in a second substantially AC electrical state having a second set of characteristics that can be, for example, associated with an external circuit. For example, in some instances, the converter 360 can convert power in a first substantially AC electrical state received from the machine winding 340 having the first set of characteristics to power in a substantially DC electrical state, and then convert the power in the substantially DC electrical state to a power in a second substantially AC electrical state having a second set of characteristics, which can be suitable for the load or other circuit (e.g., a power grid and/or the like). By way of example, in some instances, the converter 360 can receive power in a first substantially AC electrical state from the machine winding 340 having a relatively high frequency (e.g., 500 Hertz (Hz) or other high frequency) and can first, convert the power in the first substantially AC electrical state having a relatively high frequency to power in a substantially DC electrical state, and second, convert the power in the substantially DC electrical state to a power in a second substantially AC electrical state having a substantially lower frequency (e.g., 50 Hz or other low frequency), which can be provided to, for example, a power grid or the like (e.g., via the terminals 365 and 365′).

In some embodiments, the collective arrangement of the first portion 330 and the second portion 340 of the machine segment 325 can be such that a set of operating parameters of the converter 360 are associated with, for example, a current received from the machine winding 340 and no other machine winding included in a different machine segment. Said another way, the modular arrangement of the machine segment 325 can be such that the first portion 330 and the second portion 350 are electrically isolated when the machine segment 325 is not coupled to another machine segment. Thus, a set of operational characteristics associated with the converter 360 are not dependent on the function, input, and/or output of a different machine segment physically and electrically coupled to the machine segment 325. Such a modular arrangement can, for example, improve manufacturability, serviceability, converter circuit design flexibility, external circuit design flexibility, machine design flexibility, fault response (described in further detail herein), system-level fault tolerance (described in further detail herein), and/or the like. Moreover, such a modular arrangement can, for example, reduce phase-to-ground voltage, eddy currents, circulating currents, and/or the like, which in turn, can allow a reduction in a voltage rating for switching, electric insulation thickness, device voltage rating, thermal rating, and/or the like. Furthermore, such a modular arrangement can allow for substantially different machine topologies and/or architectures, which can additionally improve such characteristics as system performance, system cost, and/or system efficiency.

Furthermore, although the machine winding 340 as shown can be associated with a single electrical phase, the machine winding 340 can be associated with any number of phases. Although common electrical interconnections typically include a single electrical phase, or three electrical phases, the external electrical circuit can also be associated with any number of electrical phases. The number of electrical phases in the machine winding 340 can be different from the number of electrical phases in the external electrical circuit to which the machine segment 325 is electrically coupled.

FIG. 4 is a schematic illustration of a machine segment 425 according to an embodiment. The machine segment 425 can be, for example, substantially modular and can be physically and/or electrically coupled to one or more similar or corresponding machine segments to form a portion of an electromagnetic machine. For example, the machine segment 425 can include and/or can otherwise be disposed in a housing or the like that can define, for example, a physical boundary and/or the like of the machine segment 425. In some embodiments, the machine segment 425 can include a modular segment of the segmented stator assembly 220 included in the machine structure 200 of FIG. 2. In other embodiments, the machine segment 425 need not be physically and/or electrically coupled to similar or corresponding machine segments, as described above. In some embodiments, the machine segment 425 can be substantially similar in form and function as the machine segment 125 described above with reference to FIG. 1. For example, in some embodiments, the machine segment 425 can include a substantially modular stator segment formed by and/or otherwise including a laminated composite assembly, and a suitable electrical power converter, as described in detail above. Accordingly, such similar aspects of the machine segment 425 are generally discussed, yet not described in further detail herein.

As shown in FIG. 4, the machine segment 425 includes a first portion 430 and a second portion 450 that are physically and electrically connected. In other embodiments, the first portion 430 and the second portion 450 can be electrically connected yet physically separate. The first portion 430 can include a multi-phase machine winding 440. The machine winding 440 can be, for example, a set of conductive stator windings or the like that can carry an alternating current resulting from an electric field induced by a movement of one or more magnets relative thereto, as described in detail above with reference to FIG. 2. The alternating current carried on or by the machine winding 440 can have, for example, a magnitude, frequency, voltage, phase, and/or the like that is associated with the machine segment 425. That is to say, the alternating current resulting from the induced electric field can have a set of characteristics or the like that are dependent on and/or correspond to a set of characteristics associated with the movement of the magnets relative to the machine segment 425.

In some embodiments, the first portion 430 of the machine segment 425 can be arranged such that the machine winding 440 includes, for example, any number of portions that are each associated with a different electrical phase. Said another way, the first portion 430 of the machine segment 425 can include a multi-phase machine winding 440 formed by a number of phase portions, with each of the phase portions being associated with a different electrical phase. Each of the phase portions of the machine winding 440 can be electrically isolated from the remaining phase portions of the machine winding 440 within the first portion 430. Thus, as described herein, a machine winding can mean a single-phase machine winding or a multi-phase machine winding.

The machine winding 440 of the machine segment 425 can have, for example, a set of three phase portions that are each associated with a different electrical phase (e.g., referred to herein as “phase A,” “phase B,” and “phase C”). Each of the phase portions of the machine winding 440 includes a first terminal portion (e.g., a positive terminal) and a second terminal portion (e.g., a negative terminal). For example, as shown in FIG. 4, the machine segment 425 includes a first terminal portion 445 and a second terminal portion 445′ associated with phase A and electrically connected to a first phase portion of the machine winding 440, a first terminal portion 446 and a second terminal portion 446′ associated with phase B and electrically connected to a second phase portion of the machine winding 440, and a first terminal portion 447 and a second terminal portion 447′ associated with phase C and electrically connected to a third phase portion of the machine winding 440 (e.g., with each phase portion being included in the machine winding 440). The arrangement of the machine segment 425 is such that the terminals 445 and 445′, 446 and 446′, and 447 and 447′ are electrically isolated at least while in the first portion 430 of the machine segment 425.

As shown in FIG. 4, the second portion 450 of the machine segment 425 includes a converter 460 that is electrically connected to the terminal portions 445 and 445′ associated with the phase A, the terminal portions 446 and 446′ associated with phase B, and the terminal portions 447 and 447′ associated with phase C of the machine winding 440. The converter 460 can include any circuit and/or device (e.g., AC buses, DC buses, mechanical switching devices, electrical switching devices, conductors, resistors, capacitors, inductors, etc.) that converts electrical power from a first state to a second state, as described in detail above with reference to FIG. 3. Moreover, the converter 460 includes a first terminal 465 (e.g., a positive terminal) and a second terminal 465′ (e.g., a negative terminal). In this manner, the converter 460 can receive a flow of AC associated with phase A, a flow of AC associated with phase B, and a flow of AC, associated with phase C and, in some instances, can convert the power in the substantially AC electrical state associated with each phase into a single power in the substantially DC electrical state, which in some instances, can flow and/or be delivered to an external circuit or the like via the terminals 465 and 465′.

In other instances, the converter 460 can receive power in a first substantially AC electric state from the machine windings 440 and can convert the power in the first substantially AC electrical state having characteristics associated with the machine windings 440 to power in a second substantially AC electrical state having characteristics associated with an external circuit (e.g., an electric utility power grid and/or the like), as described in detail above with reference to FIG. 3. Expanding further, the converter 460 can receive power in a first substantially AC electrical state from the first terminal portion 445 and/or the second terminal portion 445′ associated with phase A, power in the first substantially AC electrical state from the first terminal portion 446 and/or the second terminal portion 446′ associated with phase B, and power in the first substantially AC electrical state from the first terminal portion 447 and/or the second terminal portion 447′ associated with phase C. In this manner, the power in the first substantially AC electrical state associated with phase A, phase B, and phase C can have a set of characteristics that are associated with the machine segment 425 (e.g., associated with the electric field induced in the machine windings 440) and the converter 460 can convert the power in the first substantially AC electrical state associated with phase A, the power in the first substantially AC electrical state associated with phase B, and the power in the first substantially AC electrical state associated with phase C into, for example, three-phase power in a second substantially AC electrical state associated with the external circuit (e.g., an electric utility power grid). Although the machine windings 440 are shown and described above as being associated with three phases, in other embodiments, the machine windings 440 can be associated with one phase, two phases, four phases, five phases, six phases, or more.

In some embodiments, the modular arrangement of the machine segment 425 can be such that the first portion 430 and the second portion 450 are electrically isolated from other machine segments when the machine segment 425 is not coupled to another machine segment. Thus, a set of operational characteristics associated with the converter 460 are not dependent on the function, input, and/or output of a different machine segment physically and electrically coupled to the machine segment 425. Such a modular arrangement can, for example, improve manufacturability, serviceability, circuit design flexibility, fault response (described in further detail herein), system-level fault tolerance (described in further detail herein), and/or the like. Moreover, such a modular arrangement can, for example, reduce phase-to-ground voltage, eddy currents, circulating currents, and/or the like, which in turn, can allow a reduction in a voltage rating for switching, electric insulation thickness, device voltage rating, thermal rating, and/or the like. Furthermore, such a modular arrangement can allow for substantially different machine topologies and/or architectures, which can additionally improve such characteristics as system performance, system cost, and/or system efficiency.

In some embodiments, the modular arrangement of the machine segment 425 can be such that the number of electrical phases associated with the machine segment 425 can be different from a number of phases associated with an external circuit. For example, while the external electric circuit electrically connected to the converter 460 is described as being associated with phase A, phase B, and phase C, in other embodiments, an external electrical circuit can be electrically connected to the converter 460 that is associated with, for example, a single phase (e.g., phase A). In this manner, the converter 460 can convert the power in the substantially AC electrical state associated with three electrical phases from the machine windings 440 (e.g., associated with phase A, phase B, and phase C) into power in the substantially DC electrical state, and then to power in the substantially AC electrical state associated with a single electrical phase to be delivered to the external electrical circuit. In some embodiments, the modular arrangement of the machine segment 425 can be such that an increase in the number of phases with which the machine segment is associated can, for example, increase the voltage rating of the machine segment 425. Similarly, in some embodiments, a number of phases in the machine windings 440 can be selected for a certain set of electrical and/or mechanical harmonic characteristics related to a number of electrical phases.

By way of example, in some embodiments, the machine segment 425 can be included in an electromagnetic machine that is associated with three electrical phases. In such embodiments, terminal portions associated with each phase can be electrically connected to, for example, a different switching device included in the converter 460, which can be, for example, rated at 20 kilowatts (kW). Thus, the machine segment 425 can be associated with and/or can form at least a portion of a 60 kW electrical circuit. In other embodiments, the machine segment 425 can be included in an electromagnetic machine that is associated with five electrical phases. As such, the converter 460 can include five switching devices of the same type (i.e., rated at 20 kW), with each switching device electrically connected to a different set of terminal portions associated with each electrical phase. Thus, the machine segment 425 can be associated with and/or can form at least a portion of a 100 kW electrical circuit. Hence, the modular arrangement of the machine segment 425 can allow for greater electrical circuit design flexibility than would otherwise be possible with the same number of phases on either side of the converter 460 and/or with a single converter electrically connected to multiple machine segments.

While the terminal portions 445 and 445′, 446 and 446′, and 447 and 447′ are shown as being electrically coupled to the converter 460, in other embodiments, a machine segment can include a machine winding in any suitable configuration. For example, FIG. 5 is a schematic illustration of a machine segment 525 according to an embodiment. The machine segment 525 can be, for example, substantially modular and can be physically and/or electrically coupled to one or more similar or corresponding machine segments to form a portion of an electromagnetic machine, as described above with reference to FIG. 2. In some embodiments, the machine segment 525 can be substantially similar in form and function as the machine segment 425 described above with reference to FIG. 4. Accordingly, such similar aspects of the machine segment 525 are generally discussed, yet not described in further detail herein.

As shown in FIG. 5, the machine segment 525 includes a first portion 530 having a multi-phase machine winding 540, and a second portion 550 having a converter 560. The machine winding 540 of the first portion can be, for example, a set of conductive stator windings or the like that can carry an alternating current resulting from an electric field induced by a movement of one or more magnets relative thereto, as described in detail above with reference to FIG. 2. The alternating current carried on or by the machine winding 540 can have, for example, a magnitude, frequency, voltage, phase, and/or the like that is associated with the machine segment 525. That is to say, the alternating current resulting from the induced electric field can have a set of characteristics or the like that are dependent on and/or correspond to a set of characteristics associated with the movement of a magnetic field relative to the machine segment 525.

In some embodiments, the first portion 530 of the machine segment 525 can be arranged such that the machine winding 540 includes, for example, any number of portions that are each associated with a different electrical phase, as described in detail above with reference to the machine segment 425 of FIG. 4. For example, the set of machine windings 540 can include a first phase portion with a first terminal portion 545 and a second terminal portion 545′ associated with a first phase (phase A), a second phase portion with a first terminal portion 546 and a second terminal portion 546′ associated with a second phase (phase B), and a third phase portion with first terminal portion 547 and a second terminal portion 547′ associated with a third phase (phase C).

As shown in FIG. 5, the second terminals 545′, 546′, and 547′ associated with phase A, phase B, and phase C, respectively, are electrically connected in a star configuration, at a point of common electrical connection, as described in further detail herein. The first terminals 545, 546, and 547 associated with phase A, phase B, and phase C, respectively, are electrically connected to the converter 560 included in the second portion 550 of the machine segment 525. The converter 560 can include any circuit and/or device that converts electrical power from a first state to a second state, as described in detail above with reference to FIG. 3. Moreover, the converter 560 includes a first terminal 565 (e.g., a positive terminal) and a second terminal 565′ (e.g., a negative terminal) that can electrically couple the machine segment to, for example, a load, as described in detail above. Although the machine winding 540 is shown and described above as being associated with three phases, in other embodiments, the machine winding 540 can be associated with one phase, two phases, four phases, five phases, six phases, or more.

In some instances, the converter 560 can receive a flow of power in a substantially AC electrical state associated each phase (i.e., phase A, phase B, and phase C) and, in some instances, can convert the power in the substantially AC electrical state associated with each phase into a power in the substantially DC electrical state which in some instances, can flow and/or be delivered to an external electrical circuit or the like via the terminals 565 and 565′. In other instances, the converter 560 can receive power in a first substantially AC electrical state from terminals 545, 546, and 547 with a set of characteristics associated with the machine segment 525 (e.g., associated with the electric field induced in the machine windings 540) and the converter 560 can convert the power in the first substantially AC electrical state associated with phase A, phase B, and phase C into power in a substantially DC electrical state, and from a power in the substantially DC electrical state into, for example, a power in a second substantially AC state associated with the load (e.g., a 3-phase utility power grid), as described in detail above with reference to FIG. 4. In some instances, the modular arrangement of the machine segment 525 can, for example, improve the function and/or flexibility of the machine segment 525 and/or an electrical circuit electrically coupled thereto, as described in detail above. In some instances, such a modular arrangement can, for example, reduce phase-to-ground voltage, eddy currents, circulating currents, and/or the like, which in turn, can allow a reduction in a voltage rating for switching, electric insulation thickness, device voltage rating, thermal rating, and/or the like. Furthermore, such a modular arrangement can allow for substantially different machine topologies and/or architectures which can additionally improve such characteristics as system performance, system cost, and/or system efficiency.

In some embodiments, by electrically connecting the second terminals 545′, 546′, and 547′ in a star configuration, the machine windings 540 associated with phase A, phase B, and phase C are electrically connected. In some instances, the star configuration of the second terminals 545′, 546′, and 547′ can allow the machine windings 540 to be electrically coupled to an external circuit such as, for example, a set of machine windings 540 included in a different machine segment. Moreover, although the second terminals 545′, 546′, and 547′ are shown as being electrically connected in a star configuration, in other embodiments, the first terminals 545, 546, and 547 can be electrically connected in a star configuration and the second terminals 545′, 546′, and 547′ can be electrically connected to the converter 560. Although particularly shown and described as having three electrical phases, the machine winding 540 can have any suitable number of electrical phases with a corresponding set of terminals electrically connected in a star configuration or the like.

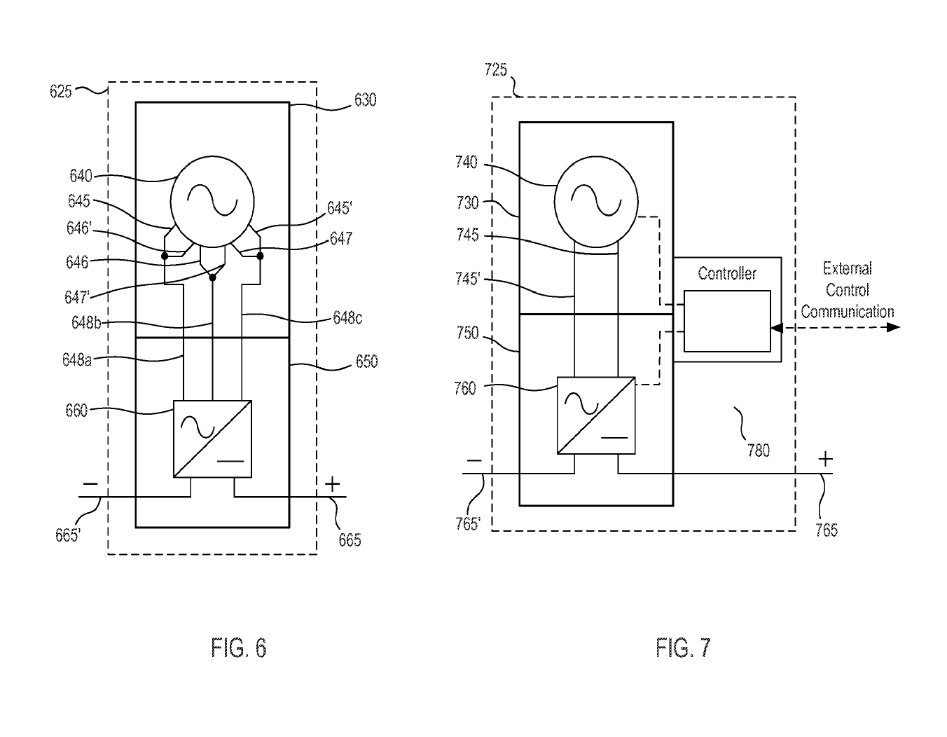

While the terminal portions 545′, 546′, and 547′ are shown as being electrically connected in a star configuration, in other embodiments, a machine segment can include a machine winding in any suitable configuration. For example, FIG. 6 is a schematic illustration of a machine segment 625 according to an embodiment. The machine segment 625 can be, for example, substantially modular and can be physically and/or electrically coupled to one or more similar or corresponding machine segments to form a portion of an electromagnetic machine, as described above with reference to FIG. 2. In some embodiments, the machine segment 625 can be substantially similar in form and function as the machine segment 425 described above with reference to FIG. 4. Accordingly, such similar aspects of the machine segment 625 are generally discussed, yet not described in further detail herein.

As shown in FIG. 6, the machine segment 625 includes a first portion 630 having a multi-phase machine winding 640, and a second portion 650 having a converter 660. The machine winding 640 of the first portion can be, for example, a set of conductive stator windings or the like that can carry an alternating current resulting from an electric field induced by a movement of one or more magnets relative thereto, as described in detail above with reference to FIG. 2. The alternating current carried on or by the machine winding 640 can have, for example, a magnitude, frequency, voltage, phase, and/or the like that is associated with the machine segment 625. That is to say, the alternating current resulting from the induced electric field can have a set of characteristics or the like that are dependent on and/or correspond to a set of characteristics associated with the movement of the magnetic field relative to the machine segment 625.

In some embodiments, the first portion 630 of the machine segment 625 can be arranged such that the machine winding 640 includes, for example, any number of portions that are each associated with a different electrical phase, as described in detail above with reference to the machine segment 425 of FIG. 4. For example, the set of machine windings 640 can include a first phase portion with a first terminal portion 645 and a second terminal portion 645′ associated with a first phase (phase A), a second phase portion with a first terminal portion 646 and a second terminal portion 646′ associated with a second phase (phase B), and a third phase portion with first terminal portion 647 and a second terminal portion 647′ associated with a third phase (phase C).

In some embodiments, the terminal portions associated with each phase can be electrically connected in a delta configuration. For example, as shown in FIG. 6, the first terminal portion 645 (e.g., a positive terminal) associated with phase A can be electrically connected to the second terminal portion 646′ (e.g., a negative terminal) associated with phase B; the first terminal portion 646 associated with phase B can be electrically connected to the second terminal portion 647′ associated with phase C; and the first terminal portion 647 associated with phase C can be electrically connected to the second terminal portion 645′ associated with phase A. Although particularly shown and described, the terminal portions can be arranged in any suitable manner according to a delta configuration. Furthermore, although particularly shown and described as having three electrical phases, machine winding 640 can have any suitable number of electrical phases (e.g., one electrical phase, two electrical phases, four electrical phases, five electrical phases, six electrical phases, or more).

In this manner, a lead 648a associated with the electrical connection between the terminal portions 645 and 646′, a lead 648b associated with the electrical connection between the terminal portions 646 and 647′, and a lead 648c associated with the electrical connection between the terminal portions 647 and 645′ can, for example, electrically connect the machine winding 640 to the converter 660 included in the second portion 650 of the machine segment 625. The converter 660 can include any circuit and/or device that converts electrical power from a first state to a second state, as described in detail above with reference to FIG. 3. Moreover, the converter 660 includes a first terminal 665 (e.g., a positive terminal) and a second terminal 665′ (e.g., a negative terminal) that can electrically couple the machine segment to, for example, a load, as described in detail above.

In some instances, the converter 660 can receive a flow of power in a substantially AC electrical state associated with each pair of phase (i.e., phases A-B, phases B-C, and phases C-A) and, in some instances, can convert the power in a substantially AC electrical state associated with each phase into power in a substantially DC electrical state, which in some instances, can flow and/or be delivered to an external circuit or the like via the terminals 665 and 665′. In other instances, the converter 660 can receive a power in a first substantially AC electrical state from leads 645a, 646b, and 647c with a set of characteristics associated with the machine segment 625 (e.g., associated with the electric field induced in the machine winding 640) and the converter 660 can convert the power in the first substantially AC electrical state associated with phase pairs A-B, phases B-C, and phases C-A into power in a substantially DC electrical state, and then from a power in the substantially DC electrical state into, for example, a power in a second substantially AC electrical state associated with the external circuit (e.g., a 3-phase utility power grid), as described in detail above with reference to FIG. 4. In some instances, the modular arrangement of the machine segment 625 can, for example, improve the function and/or flexibility of the machine segment 625 and/or an electrical circuit electrically coupled thereto, as described in detail above. In some embodiments, by electrically connecting the terminals 645 and 645′, 646 and 646′, and 647 and 647′ in a delta configuration, the power in a substantially AC electrical state provided to the converter 660 can have a desired set of characteristics (e.g., voltage or the like). Moreover, in some instances, by electrically connecting the terminal portions in a delta configuration, the performance, flexibility, and/or reliability of the electrical circuit included in the machine segment 625 can be improved.

FIG. 7 is a schematic illustration of a machine segment 725 according to an embodiment. The machine segment 725 can be, for example, substantially modular and can be physically and/or electrically coupled to one or more similar or corresponding machine segments to form a portion of an electromagnetic machine, as described above with reference to FIG. 2. For example, the machine segment 725 can include and/or can otherwise be disposed in a housing or the like that can define, for example, a physical boundary and/or the like of the machine segment 725. In some embodiments, the machine segment 725 can be substantially similar, at least in part, in form and function to the machine segment 325 described above with reference to FIG. 3. Accordingly, such similar aspects of the machine segment 725 are generally discussed, yet not described in further detail herein.

As shown in FIG. 7, the machine segment 725 includes a first portion 730 having a machine winding 740, and a second portion 750 having a converter 760. The machine winding 740 of the first portion 730 can be, for example, a set of conductive stator windings, rotor windings, or the like that can carry an alternating current resulting from an electric field induced by a movement of one or more magnets relative thereto, as described in detail above with reference to FIG. 2. The alternating current carried on or by the machine winding 740 can have a set of characteristics such as, for example, a magnitude, frequency, voltage, phase, and/or the like that are associated with the machine segment 725 (e.g., dependent on and/or correspond to a set of characteristics associated with the movement of the magnets relative to the machine segment 725), as described above.

In some embodiments, the first portion 730 of the machine segment 725 can be arranged such that the machine winding 740 includes a single machine winding associated with a single phase. The machine winding 740 can include a first terminal portion 745 and a second terminal portion 745′ which are each electrically connected to the converter 760 included in the second portion 750 of the machine segment 725, as described above with reference to the machine segment 325 of FIG. 3. The converter 760 can include any circuit and/or device that converts electrical power from a first state to a second state, as described in detail above with reference to FIG. 3. Moreover, the converter 760 can include a first terminal 765 (e.g., a positive terminal) and a second terminal 765′ (e.g., a negative terminal) that can electrically couple the machine segment to, for example, a load, as described in detail above.

In some instances, the converter 760 can receive a flow of power in a substantially AC electrical state from the machine winding 740 and can convert the power in the substantially AC electrical state into a power in a substantially DC electrical state, which, in some instances, can flow and/or be delivered to an external circuit or the like via the terminals 765 and 765′. In other instances, the converter 760 can receive power in a first substantially AC electrical state from the terminals 745 and 745′ with a set of characteristics associated with the machine segment 725 (e.g., associated with the electric field induced in the machine windings 740) and the converter 760 can convert power in the first substantially AC electrical state into power in a substantially DC electrical state, and then convert power in the substantially DC electrical state into power in a second substantially AC electrical state associated with an external electrical circuit (e.g., an electrical utility power grid), as described in detail above with reference to FIG. 3. In some instances, the modular arrangement of the machine segment 725 can, for example, improve the function and/or flexibility of the machine segment 725 and/or an electrical circuit electrically coupled thereto, as described in detail above.

As shown in FIG. 7, the machine segment 725 also includes a controller 780. More specifically, the machine segment 725 can include and/or can otherwise be disposed in the housing or the like (described above), which can similarly house the controller 780. Thus, such a housing can define a physical boundary or the like of the machine segment 725, within which the controller 780 is disposed. The controller 780 can be any suitable control circuit or the like. For example, in some embodiments, the controller 780 can include any number of insulated-gate bipolar transistors (IGBT), metal-oxide semiconductor field-effect transistors (MOSFET), and/or the like. In some instances, the controller 780 can be a proportional-integral-derivative (PID) controller, programmable logic controller (PLC), or the like. In this manner, the controller 780 can substantially control the operation of portions of the converter 760 and/or any other portion of the machine segment 725. Furthermore, in some instances, the controller 780 can receive a signal from the machine winding 740, the converter 760, or any other portion of the machine segment 725, and on receipt of the signal, can substantially control the operation of portions of the converter 760 and/or any other portion of the machine segment 725 More particularly, the controller 780 can send a control signal that can include instructions for and/or otherwise result in, for example, normal operation of the machine segment 725, and/or higher-level control of the machine segment 725 such as, load balancing, voltage balancing, synchronization between machine segments, and/or fault response. In some instances, the controller 780 can be configured to communicate (e.g., via a wired or wireless connection) with, for example, a controller included in one or more other machine segments (e.g., machine segments arranged with machine segment 725 to form a portion of a machine), such that a signal can be received by the controller 780 from the one or more other machine segments and/or sent from the controller 780 to the one or more other machine segments. In some instances, the controller 780 can receive a signal from or send a signal to any device outside the machine segment 725, and the controller can control the operation of at least a portion of the machine segment 725 based on such a signal. Thus, the controllers 780 of each machine segment can collectively perform one or more processes and/or functions associated with such operations described above.

As described above, in some instances, the controller 780 can be configured to act substantially independently (e.g., can include a memory or the like that can include a set of instructions executed by, for example, a processing unit or the like) to substantially control the operation of portions of the machine segment 725. In other embodiments, the controller 780 can receive an external signal from, for example, a system-level controller, or the like (as indicated by the dashed arrow in FIG. 7). In such embodiments, the functionality of such a signal can include instructions for and/or otherwise result in, for example, normal operation of the machine segment 725, and/or higher-level control of the machine segment 725 such as load balancing, voltage balancing, synchronization between segments, or fault response. In some embodiments, the machine segment 725 need not include the controller 780 and, alternatively, the converter 760 and/or other portion of the machine segment 725 can, for example, receive a signal from an external controller or the like.

Although the machine segment 725 is described above as including a machine winding 740 associated with a single phase, in other embodiments, the machine segment 725 can be arranged such that the first portion 730 includes a multi-phase machine winding 740, formed by separate winding portions that are each associated with a different electrical phase, as described in detail above with reference to the machine segment 425 of FIG. 4. In this manner, the controller 780 can be configured to control the multi-phase machine segment 725 in a substantially similar manner as described above.

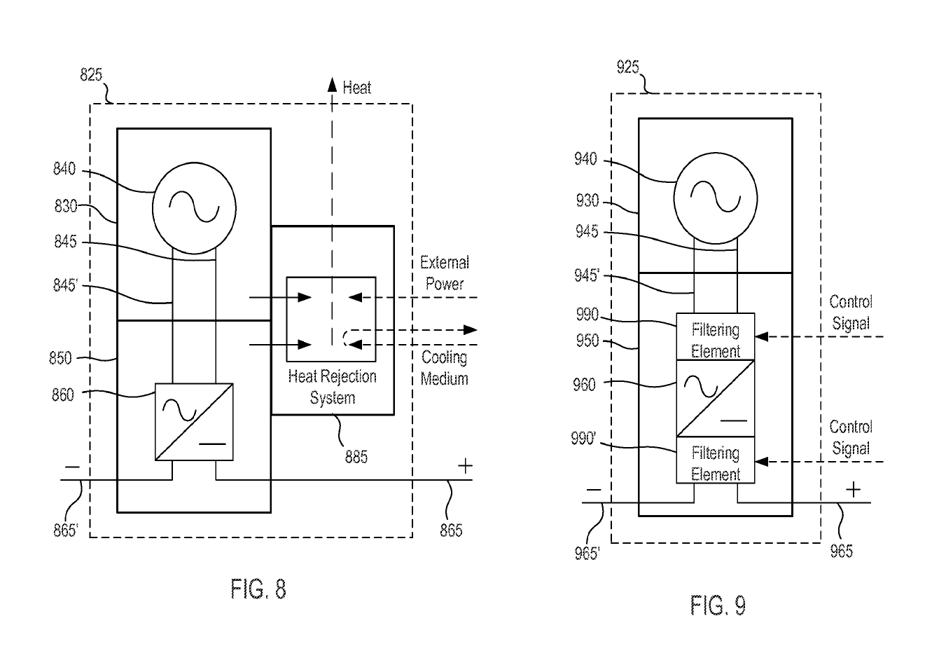

FIG. 8 is a schematic illustration of a machine segment 825 according to an embodiment. The machine segment 825 can be, for example, substantially modular and can be physically and/or electrically coupled to one or more similar or corresponding machine segments to form a portion of an electromagnetic machine, as described above with reference to FIG. 2. In some embodiments, the machine segment 825 can be substantially similar, at least in part, in form and function to the machine segment 325 described above with reference to FIG. 3. Accordingly, such similar aspects of the machine segment 825 are generally discussed, yet not described in further detail herein.

As shown in FIG. 8, the machine segment 825 includes a first portion 830 having a machine winding 840, and a second portion 850 having a converter 860. The machine winding 840 of the first portion 830 can be, for example, a set of conductive stator windings or the like that can carry an alternating current resulting from an electric field induced by a movement of one or more magnets relative thereto, as described in detail above with reference to FIG. 2. The alternating current carried on or by the machine winding 840 can have a set of characteristics such as, for example, a magnitude, frequency, voltage, phase, and/or the like that are associated with the machine segment 825 (e.g., dependent on and/or correspond to a set of characteristics associated with the movement of the magnets relative to the machine segment 825), as described above.

In some embodiments, the first portion 830 of the machine segment 825 can be arranged such that the machine winding 840 is associated with a single electrical phase. The machine winding 840 can include a first terminal portion 845 and a second terminal portion 845′ which are each electrically connected to the converter 860 included in the second portion 850 of the machine segment 825, as described above with reference to the machine segment 325 of FIG. 3. The converter 860 can include any circuit and/or device that converts electrical power from a first state to a second state, as described in detail above with reference to FIG. 3. Moreover, the converter 860 includes a first terminal 865 (e.g., a positive terminal) and a second terminal 865′ (e.g., a negative terminal) that can electrically couple the machine segment to, for example, a load (e.g., an external electrical circuit), as described in detail above.

In some instances, the converter 860 can receive power in a substantially AC electrical state from the machine winding 840 and can convert the power in the substantially AC electrical state into power in a substantially DC electrical state, which in some instances, can flow and/or be delivered to an external electrical circuit or the like via the terminals 865 and 865′. In other instances, the converter 860 can receive power in a first substantially AC electrical state from the terminals 845 and 845′ with a set of characteristics associated with the machine segment 825 (e.g., associated with the electric field induced in the machine winding 840) and the converter 860 can convert the power in the first substantially AC electrical state into power in a substantially DC electrical state, and then convert the power in the substantially DC electrical state into, for example, power in a second substantially AC electrical state associated with the external circuit (e.g., an electric utility power grid), as described in detail above with reference to FIG. 3. In some instances, the modular arrangement of the machine segment 825 can, for example, improve the function and/or flexibility of the machine segment 825 and/or an electrical circuit electrically coupled thereto, as described in detail above.

Although the machine segment 825 is described above as including a machine winding 840 associated with a single phase, in other embodiments, the machine segment 825 can be arranged such that the first portion 830 includes a multi-phase machine winding 840, formed by separate winding portions that are each associated with a different electrical phase, as described in detail above with reference to the machine segments 425, 525, and/or 625 of FIGS. 4-6 respectively.

As shown in FIG. 8, the machine segment 825 can also include a heat rejection system 885. The heat rejection system 885 can be any suitable device, mechanism, system, and/or the like that is configured to maintain at least a portion of the machine segment 825 at or near a suitable operating temperature. For example, in some embodiments, the heat rejection system 885 can be a substantially passive system including, for example, heat sinks, cold plates, and the like. In some embodiments, the heat rejection system 885 can be a substantially active system that can include one or more electrical components and/or devices. In such embodiments, the heat rejection system 885 can, for example, receive electrical power from electricity available from the operation of the machine segment 885 (e.g., from the power in the substantially AC electrical state carried along the machine winding 840), or can have some other externally supplied source of electrical power as shown by the dashed arrow in FIG. 5. In a similar manner, in some embodiments, the heat rejection system 885 can be configured to receive an external flow of a cooling medium such as air, water, coolant, and/or any other suitable gas, liquid, multi-phase, or other transportable medium. In such embodiments, the flow of cooling medium can be in a substantially closed loop system or a substantially open loop system. Thus, the cooling medium can be passed along a surface of, for example, a heat sink or the like, thereby removing heat in a substantially similar manner as in known thermodynamic systems. As described above with reference to the machine segment 725, in some embodiments, the heat rejection system 885 and the remaining portions of the machine segment 825 can be disposed within a housing or the like that can define a physical boundary or the like of the machine segment 825. In other embodiments, the heat rejection system 885 can form a portion of such a housing (e.g., forms a surface that can include, for example, cooling fins, or the like).

FIG. 9 is a schematic illustration of a machine segment 925 according to an embodiment. The machine segment 925 can be, for example, substantially modular and can be physically and/or electrically coupled to one or more similar or corresponding machine segments to form a portion of an electromagnetic machine, as described above with reference to FIG. 2. In some embodiments, the machine segment 925 can be substantially similar, at least in part, in form and function to the machine segment 325 described above with reference to FIG. 3. Accordingly, such similar aspects of the machine segment 925 are generally discussed, yet not described in further detail herein.

As shown in FIG. 9, the machine segment 925 includes a first portion 930 having a machine winding 940, and a second portion 950 having a converter 960. The machine winding 940 of the first portion 930 can be, for example, a set of conductive stator windings or the like that can carry an alternating current resulting from an electric field induced by a movement of one or more magnets relative thereto, as described in detail above with reference to FIG. 2. The alternating current carried on or by the machine winding 940 can have a set of characteristics such as, for example, a magnitude, frequency, voltage, phase, and/or the like that are associated with the machine segment 925 (e.g., dependent on and/or correspond to a set of characteristics associated with the movement of the magnets relative to the machine segment 925), as described above.

In some embodiments, the first portion 930 of the machine segment 925 can be arranged such that the machine winding 940 is associated with a single electrical phase. The machine winding 940 includes a first terminal portion 945 and a second terminal portion 945′, which are each electrically connected to the converter 960 included in the second portion 950 of the machine segment 925, as described above with reference to the machine segment 325 of FIG. 3. The converter 960 can include any circuit and/or device that converts electrical power from a first state to a second state, as described in detail above with reference to FIG. 3. Moreover, the converter 960 includes a first terminal 965 (e.g., a positive terminal) and a second terminal 965′ (e.g., a negative terminal) that can electrically couple the machine segment to, for example, a load, as described in detail above.

In some instances, the converter 960 can receive a flow of power in a substantially AC electrical state from the machine winding 940 and can convert the power in the substantially AC electrical state into power in a substantially DC electrical state, which, in some instances, can flow and/or be delivered to an external electrical circuit or the like via the terminals 965 and 965′. In other instances, the converter 960 can receive power in a first substantially AC electrical state from the terminals 945 and 945′ with a set of characteristics associated with the machine segment 925 (e.g., associated with the electric field induced in the machine winding 940) and the converter 960 can convert the power in the first substantially AC electrical state into power in a substantially DC electrical state, and then convert the power in the substantially DC electrical state into, for example, power in a second substantially AC electrical state associated with the external electrical circuit (e.g., an electric utility power grid), as described in detail above with reference to FIG. 3. In some instances, the modular arrangement of the machine segment 925 can, for example, improve the function and/or flexibility of the machine segment 925 and/or an electrical circuit electrically coupled thereto, as described in detail above.

Although the machine segment 925 is described above as including a machine winding 1040 associated with a single phase, in other embodiments, the machine segment 925 can be arranged such that the first portion 930 includes a multi-phase machine winding 940, formed by separate winding portions that are each associated with a different electrical phase, as described in detail above with reference to the machine segments 425, 525, and/or 625 of FIGS. 4-6 respectively.

As shown in FIG. 9, the machine segment 925 can also include a first electrical filtering element 990 and/or a second electrical filtering element 990′. The electrical filtering elements 990 and/or 990′ can be any suitable device, mechanism, element, and/or the like that can be configured to, for example, improve one or more characteristics associated with a flow of an electrical power and/or current through the machine segment 925, such as a reduction in harmonic content, current ripple, and the like. For example, in some embodiments, the electrical filtering elements 990 and/or 990′ can be substantially passive elements including, for example, inductors, capacitors, and/or the like. In other embodiments, the electrical filtering elements 990 and/or 990′ can be substantially active elements including, for example, filtering circuits, IGBTs, MOSFETs, and/or the like. In some embodiments, the electrical filtering elements 990 and 990′ can be substantially similar. In other embodiments, the electrical filtering elements 990 and 990′ can be different, where, for instance, the first electrical filtering element 990 provides filtering of an AC current, and the second electrical filtering element 990′ provides filtering of a DC current.

As shown, the arrangement of the machine segment 925 can be such that the first electrical filtering element 990 is electrically connected in series between the machine winding 940 and the converter 960 and the second electrical filtering element 990′ is electrically connected in series between the converter 960 and the terminals 965 and 965′. Thus, a flow of AC or DC can be filtered prior to entering the converter 960 and a flow of AC or DC can be filtered after leaving the converter 960. Although the electrical filtering elements 990 and 990′ are shown in FIG. 9 as being disposed “upstream” and “downstream,” respectively, of the converter 960, in other embodiments, the machine segment 925 can include a single electrical filtering element 990 that is either upstream of the converter 960 or downstream of the converter 960. In other embodiments, the arrangement of the machine segment 925 can be such that the first electrical filtering element 990 is electrically connected in series downstream of the converter 960 and prior to the terminal 965. Similarly, the arrangement of the machine segment 925 can be such that the second electrical filtering element 990′ is electrically connected in series downstream of the converter 960 and prior to the terminal 965′. Thus, the first electrical filtering element 990 and the second filtering element 990′ can filter a flow of AC or DC through the terminals 965 and 965′. Although described as including the first electrical filtering element 990 electrically connected in series between the converter 960 and the terminal 965 and the second electrical filtering element 990′ electrically connected in series between the converted 960 and the terminal 965′, in other embodiments, the machine segment 925 can include either the first electrical filtering element 990 or the second electrical filtering element 990′. In still other embodiments, the machine segment 925 can include one or more devices (e.g., a controller or the like) that can receive a signal associated with and/or otherwise operable to filter the flow of AC or DC prior to and/or after being converted by the converter 960. Said another way, in some embodiments, the electrical filtering elements 990 and/or 990′ can receive, for example, a control signal or communication from a controller or the like included in the machine segment 925 and/or external to the machine segment 925.

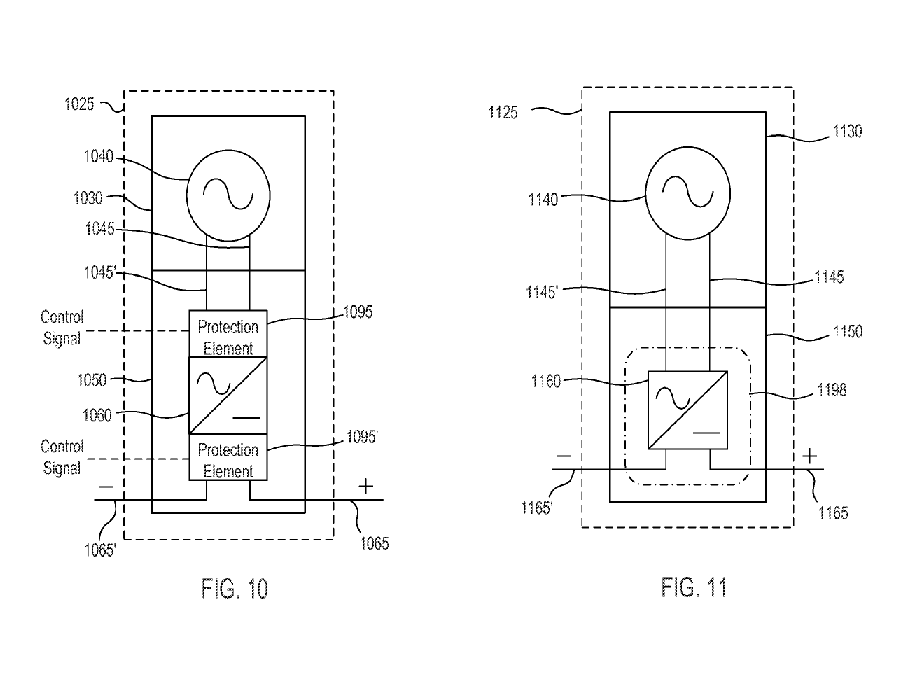

FIG. 10 is a schematic illustration of a machine segment 1025 according to an embodiment. The machine segment 1025 can be, for example, substantially modular and can be physically and/or electrically coupled to one or more similar or corresponding machine segments to form a portion of an electromagnetic machine, as described above with reference to FIG. 2. In some embodiments, the machine segment 1025 can be substantially similar, at least in part, in form and function to the machine segment 325 described above with reference to FIG. 3. Accordingly, such similar aspects of the machine segment 1025 are generally discussed, yet not described in further detail herein.

As shown in FIG. 10, the machine segment 1025 includes a first portion 1030 having a machine winding 1040, and a second portion 1050 having a converter 1060. The machine winding 1040 of the first portion 1030 can be, for example, a set of conductive stator windings, rotor windings or the like that can carry an alternating current resulting from an electric field induced by a movement of one or more magnets relative thereto, as described in detail above with reference to FIG. 2. The alternating current carried on or by the machine winding 1040 can have a set of characteristics such as, for example, a magnitude, frequency, voltage, phase, and/or the like that are associated with the machine segment 1025 (e.g., dependent on and/or correspond to a set of characteristics associated with the movement of the magnets relative to the machine segment 1025), as described above.

In some embodiments, the first portion 1030 of the machine segment 1025 can be arranged such that the machine winding 1040 is associated with a single electrical phase. The machine winding 1040 can include a first terminal portion 1045 and a second terminal portion 1045′ which are each electrically connected to the converter 1060 included in the second portion 1050 of the machine segment 1025, as described above with reference to the machine segment 325 of FIG. 3. The converter 1060 can include any circuit and/or device that converts electrical power from a first state to a second state, as described in detail above with reference to FIG. 3. Moreover, the converter 1060 includes a first terminal 1065 (e.g., a positive terminal) and a second terminal 1065′ (e.g., a negative terminal) that can electrically couple the machine segment to, for example, a load, as described in detail above.

In some instances, the converter 1060 can receive power in a substantially AC electrical state from the machine winding 1040 and can convert the power in the substantially AC electrical state into power in a substantially DC electrical state, which, in some instances, can flow and/or be delivered to an external electrical circuit or the like via the terminals 1065 and 1065′. In other instances, the converter 1060 can receive power in a first substantially AC electrical state from the terminals 1045 and 1045′ with a set of characteristics associated with the machine segment 1025 (e.g., associated with the electric field induced in the machine winding 1040) and the converter 1060 can convert the power in the first substantially AC electrical state into power in a substantially DC electrical state, and convert the power in the substantially DC electrical state into, for example, power in a second substantially AC electrical state associated with an external electrical circuit (e.g., an electric utility power grid), as described in detail above with reference to FIG. 3. In some instances, the modular arrangement of the machine segment 1025 can, for example, improve the function and/or flexibility of the machine segment 1025 and/or an electrical circuit electrically coupled thereto, as described in detail above.

Although the machine segment 1025 is described above as including a machine winding 1040 associated with a single phase, in other embodiments, the machine segment 1025 can be arranged such that the first portion 1030 includes a multi-phase machine winding 1040, formed by separate winding portions that are each associated with a different electrical phase, as described in detail above with reference to the machine segments 425, 525, and/or 625 of FIGS. 4-6 respectively.

As shown in FIG. 10, the machine segment 1025 can also include a first protection element 1095 and/or a second protection element 1095′. Each protection element 1095 and/or 1095′ can be any suitable device, mechanism, element, and/or the like that can be configured to, for example, reduce, limit, and/or block a current through the machine segment 1025, limit and/or substantially reduce and/or eliminate voltage through the machine segment, and/or protect the machine winding 1040 and/or the converter 1060 by reducing and/or substantially eliminating current and/or voltage through the machine windings 1040 or the converter 1060, respectively. For example, in some embodiments, the protection elements 1095 and/or 1095′ can be any suitable device or circuit such as, a fuse, a circuit breaker, a switch, and/or the like. In some embodiments, the protection elements 1095 and/or 1095′ can be and/or can include, for example, IGBTs, MOSFETs, and/or any other suitable devices that can be controlled, for example, by a controller and/or a control signal. In some embodiments, the protection elements 1095 and/or 1095′ can be substantially similar to or the same as those described in U.S. patent application Ser. No. 13/972,325 entitled, “Methods and Apparatus for Protection in a Multi-Phase Machine,” filed Aug. 21, 2013, the disclosure of which is incorporated by reference herein in its entirety.

In some embodiments, the protection elements 1095 and/or 1095′ can be “initiated” (e.g., tripped, blown, broken, and/or otherwise transitioned from a first state to a second state) based at least in part on reaching, for example, a predetermined limit on such characteristics as voltage, current, operating temperature, mechanical load, and/or the like. In addition, in some embodiments, the protection elements 1095 and/or 1095′ can be configured to send a signal to and/or receive a signal from a protection element, a controller, and/or any other suitable device operably coupled thereto (e.g., a system controller, a second machine segment coupled to the machine segment 1025, and/or the like) such that a segmented portion of an electromagnetic machine (e.g., a segmented stator) can provide a coordinated fault response between multiple machine segments.

As shown, the arrangement of the machine segment 1025 can be such that the first protection element 1095 is electrically connected in series between at least one of terminal 1045 or terminal 1045′ and the converter 1060 and the second protection element 1095′ is electrically connected in series between the converter 1060 and at least one of terminals 1065 and 1065′. Thus, the first protection element 1095 can be configured to protect the machine winding 1040 from an undesirable electrical state of the converter 1060, and vice versa. The second protection element 1095′ can be configured to protect the machine segment 1025 from an undesirable electrical state of an electrical circuit to which the machine segment 1025 is electrically connected.

FIG. 11 is a schematic illustration of a machine segment 1125 according to an embodiment. The machine segment 1125 can be, for example, substantially modular and can be physically and/or electrically coupled to one or more similar or corresponding machine segments to form a portion of an electromagnetic machine, as described above with reference to FIG. 2. In some embodiments, the machine segment 1125 can be substantially similar, at least in part, in form and function to the machine segment 325 described above with reference to FIG. 3. Accordingly, such similar aspects of the machine segment 1125 are generally discussed, yet not described in further detail herein.

As shown in FIG. 11, the machine segment 1125 includes a first portion 1130 having a machine winding 1140, and a second portion 1150 having a converter 1160. The machine winding 1140 of the first portion 1130 can be, for example, a set of conductive stator windings, rotor windings, or the like that can carry an alternating current resulting from an electric field induced by a movement of one or more magnets relative thereto, as described in detail above with reference to FIG. 2. The alternating current carried on or by the machine winding 1140 can have a set of characteristics such as, for example, a magnitude, frequency, voltage, phase, and/or the like that are associated with the machine segment 1125 (e.g., dependent on and/or correspond to a set of characteristics associated with the movement of the magnets relative to the machine segment 1125), as described above.

In some embodiments, the first portion 1130 of the machine segment 1125 can be arranged such that the machine winding 1140 is associated with a single phase. The machine winding 1140 includes a first terminal portion 1145 and a second terminal portion 1145′ which are each electrically connected to the converter 1160 included in the second portion 1150 of the machine segment 1125, as described above with reference to the machine segment 325 of FIG. 3. The converter 1160 can include any circuit and/or device that converts electrical power from a first state to a second state, as described in detail above with reference to FIG. 3. Moreover, the converter 1160 includes a first terminal 1165 (e.g., a positive terminal) and a second terminal 1165′ (e.g., a negative terminal) that can electrically couple the machine segment to, for example, a load, as described in detail above.

In some instances, the converter 1160 can receive power in a substantially AC electrical state from the machine winding 1140 and can convert the power in the substantially AC electrical state into power in a substantially DC state, which, in some instances, can flow and/or be delivered to an external circuit or the like via the terminals 1165 and 1165′. In other instances, the converter 1160 can receive power in a first substantially AC electrical state from the terminals 1145 and 1145′ with a set of characteristics associated with the machine segment 1125 (e.g., associated with the electric field induced in the machine winding 1140) and the converter 1160 can convert the power in the first substantially AC electrical state into power in a substantially DC electrical state, and then convert the power in the substantially DC electrical state into, for example, power in a second substantially AC electrical state associated with an external electrical circuit (e.g., an electric utility power grid), as described in detail above with reference to FIG. 3. In some instances, the modular arrangement of the machine segment 1125 can, for example, improve the function and/or flexibility of the machine segment 1125 and/or an electrical circuit electrically coupled thereto, as described in detail above.

Although the machine segment 1125 is described above as including a machine winding 1140 associated with a single phase, in other embodiments, the machine segment 1125 can be arranged such that the first portion 1130 includes a multi-phase machine winding 1140, formed by separate winding portions that are each associated with a different electrical phase, as described in detail above with reference to the machine segments 425, 525, and/or 625 of FIGS. 4-6 respectively.

As shown in FIG. 11, the machine segment 1125 also includes an electromagnetic interference (EMI) shield 1198. The EMI shield 1198 can be any suitable device, mechanism, element, and/or the like that can be configured to, for example, to limit and/or block EMI from reaching a particular area, portion, and/or device, and/or limit and/or block EMI that is emitted from a particular area, portion, and/or device. For example, in some embodiments, the EMI shield 1198 can include and/or can be formed from a material that substantially reduces or prevents EMI from passing therethrough such as, for example, a metallic sheet of mesh or wire. In some embodiments, the EMI shield 1198 can be implemented upon and/or otherwise disposed about substantially the entire machine segment 1125 and all of its components, or upon and/or about a portion of the components included in the machine segment 1125 such as, for example, the machine winding 1140, the converter 1160, a controller (not shown in FIG. 11), a set of filtering elements (not shown in FIG. 11), a set of protection elements (not shown in FIG. 11), and/or any other component of the machine segment 1125 (not shown in FIG. 11). For example, although the EMI shield 1198 is shown in FIG. 11 as being disposed about the converter 1160, in other embodiments, the EMI shield 1198 can be disposed about the entire second portion 1150, the entire first portion 1130 (in such a manner that current can still be induced on the machine winding 1140), the entire machine segment 1125 and/or any suitable portion thereof. Moreover, any of the components of the machine segment 1125 can be collectively disposed within the EMI shield 1198 or independently disposed in the EMI shield 1198. Furthermore, multiple EMI shields 1198 can be disposed within a machine segment 1125 in any suitable locations.

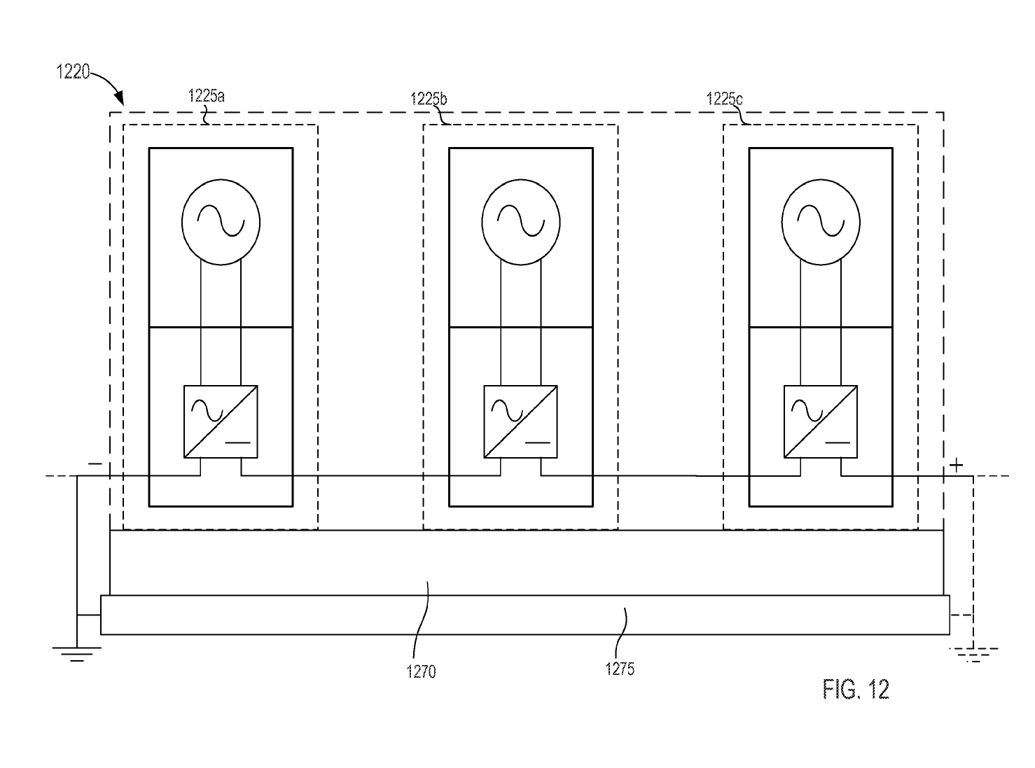

While not shown in FIGS. 1-11, any of the machine segments 125, 325, 425, 525, 625, 725, 825, 925, 1025, and/or 1125 can be physically and/or electrically coupled to any number of additional machine segments. Said another way, if the machine segment is, for example, a stator segment, then that stator segment (i.e., the machine segment) can be physically and/or electrically coupled to one or more other stator segments (i.e., a similar machine segment). For example, FIG. 12 is a schematic illustration of a machine portion 1220 according to an embodiment. The machine portion 1220 can be a portion of an electromagnetic machine, and can be part of, for example, a stator assembly or a rotor assembly of the electromagnetic machine. In some embodiments, the machine portion 1220 can be substantially similar to or the same as the stator assembly 220 included in the machine structure 200 of FIG. 2. Thus, the machine portion 1220 can be, for example, a segmented stator or the like that can include any number of machine segments that are physically and/or electrically coupled together. In some embodiments, the machine portion 1220 can be an annular segmented stator that is included in, for example, an axial flux electromagnetic machine.

As shown in FIG. 12, the machine portion 1220 can include a first machine segment 1225a, a second machine segment 1225b, and a third machine segment 1225c. The first machine segment 1225a, the second machine segment 1225b, and the third machine segment 1225c can be any suitable configuration such as, for example, those described above with reference to FIGS. 1-11. More specifically, in some embodiments, the machine segments 1225a, 1225b, and 1225c can be substantially similar in form and/or function as the machine segments described above with reference to FIGS. 3-11. Accordingly, such similar aspects of the machine segments 1225a, 1225b, and 1225c are generally discussed, yet not described in further detail herein.

As described in detail above with reference to the machine segment 325 of FIG. 3, each of the machine segments 1225a, 1225b, and 1225c includes a first portion and a second portion that are physically and electrically connected. The machine windings can be, for example, a set of conductive stator windings or the like that can carry an alternating current resulting from an electric field induced by a movement of one or more magnets relative thereto. Thus, the alternating current carried on or by the machine winding can have a set of characteristics associated with the movement of the magnets relative to each machine segment 1225a, 1225b, and 1225c, as described in detail above. The converter of each machine segment 1225a, 122b, and 1225c is electrically coupled to the corresponding machine winding. Thus, the converter can receive a flow of power in a substantially AC electrical state from the machine winding and can, for example, convert the power in the substantially AC electrical state with a set of characteristics associated with the electric field induced in the machine winding 1140 into power in a substantially DC electrical state. In this manner, the machine segments 1225a, 122b, and 122c can be structurally and functionally similar to or the same as the machine segment 325 described in detail above with reference to FIG. 3.

The machine segments 1225a, 1225b, and 1225c can be substantially modular and can be configured to be physically and/or electrically coupled and/or connected, for example, in electrical series. In this manner, prior to being physically and electrically connected, the machine segments 1225a, 1225b, and 1225c can each be electrically isolated and once connected, the machine segments 1225a, 1225b, and 1225c can be arranged in electrical series, as shown in FIG. 12. More specifically, a first input/output or terminal (e.g., a positive terminal) of the first machine segment 1225a can be electrically coupled to a second input/output or terminal (e.g., a negative terminal) of the second machine segment 1225b, and a first input/output or terminal of the second machine segment 1225b can be electrically coupled to a second input/output or terminal of the third machine segment 1225c. Thus, the machine segments 1225a, 1225b, and 1225c are electrically connected in series. Furthermore, as shown in FIG. 12, a second input/output or terminal of the first machine segment 1225a can be electrically connected, for example, to a ground. In some embodiments, a first input/output or terminal of the third machine segment 1225c can be electrically connected to a ground. In other embodiments, the first input/output or terminal of the third machine segment 1225c can be electrically connected to any suitable device, circuit, and/or the like. For example, in some embodiments, the first input/output or terminal of the third machine segment 1225c can be electrically connected to an additional machine segment (not shown in FIG. 12). In still other embodiments, the second input/output or terminal of the first machine segment 1225a and the first input/output or terminal of the third machine segment 1225c can each be electrically connected to a corresponding set of input/output or terminals of an electrical device such as, for example, an inverter or the like.

The machine portion 1220 also includes an electrical insulator 1270 and a support structure 1275. The support structure 1275 can be any suitable structure configured to support the machine portion 1220 within, for example, an electromagnetic machine. More particularly, the support structure 1275 can maintain the machine portion 1220 and thus, the machine segments 1225a, 1225b, and 1225c in a substantially fixed position within the electromagnetic machine. In some embodiments, the support structure 1275 can be formed from an electrically conductive material (e.g., iron, steel, etc.). In some embodiments, the support structure 1275 can be, for example, electrically neutral such that the machine segments 1225a, 1225b, and 1225c can be electrically grounded or otherwise electrically referenced thereto.

The electrical insulator 1270 can be any suitable arrangement that is configured provide electrical isolation at the boundary of one or more of the machine segments 1225a, 1225b, and 1225c. In some instances, the electrical insulator 1270 can provide a level of electrical isolation to the mechanical and/or electrical connection of one or more of the machine segments 1225a, 1225b and 1225c, to isolate the voltage that is accumulated from the machine segments 1225a, 1225b, and 1225c being electrically coupled in series. In some instances, the electrical insulator 1270 can provide electrical isolation to other portions of the machine portion 1220 due, at least in part, to the power in the substantially AC electrical state associated with each machine segment 1225a, 1225b, and 1225c. In some embodiments, the electrical insulator 1270 can be configured to electrically isolate at least a portion of each machine segment 1225a, 1225b, and 1225c from the remaining machine segments, thereby substantially preventing, for example, a short circuit or fault condition. In some embodiments, the electrical insulator 1270 can be formed from multiple separate portions that, in combination, perform as described above. Thus, the electrical insulator 1270 can be a system-level insulator, a machine segment boundary insulator, and/or the like.

As described above, the modular arrangement of the machine segments 1225a, 1225b, and 1225c can, in some instances, allow at least one of the components forming the machine segments 1225a, 1225b, and 1225c to have a lower electrical isolation, internal isolation rating and/or device rating or the like than the electrical insulator 1270 due, at least in part, to the machine windings and/or the converters of each machine segment 1225a, 1225b, and 1225c not accumulating voltage that would otherwise accumulate in non-modular arrangements. Said another way, the accumulation of voltage resulting from machine segments 1225a, 1225b, and 1225c being electrically coupled in series can require a level of electrical isolation at the boundary of each of the machine segments 1225a, 1225b, and 1225c, that is higher than the level of electrical isolation within any one machine segment from the machine segments 1225a, 1225b, and 1225c. Furthermore, the arrangement of the converter disposed in the second portion of each machine segment 1225a, 1225b, and 1225c can be such that electrical insulation and/or electric devices included in each machine segment 1225a, 1225b, and 1225c can have a lower voltage rating than would otherwise be needed, for example, in a non-segmented configuration using a single converter for a greater portion of the machine winding of a machine portion.

By way of example, in some embodiments, the machine segments 1225a, 1225b, and 1225c can each be 100 volt (V) machine segments with, for example, at least a 100V isolation rating and/or device rating associated with the electrical isolation of the components that form the machine segments 1225a, 1225b, and 1225c. Thus, with the machine segments 1225a, 1225b, and 1225c electrically connected in series, the electrical insulator 1270 can have at least a 300V isolation rating to electrically isolate the support structure 1275 (and/or any other machine structure) from the boundary of the machine segments 1225a, 1225b, and 1225c. In some embodiments, adding additional machine segments (substantially similar to the machine segments 1225a, 1225b, and 1225c) in series can be such that the isolation rating and the voltage of each machine segment can remain substantially unchanged and the isolation rating of the electrical insulator 1270 can be correspondingly increased. Said another way, with the machine segments of the machine portion 1220 electrically connected in series, an addition of one or more machine segments increases a system-level voltage (due to the fact that voltage is additive when elements are electrically connected in series) and in turn, the isolation rating of the electrical insulator 1270 (e.g., the system-level insulator) can be correspondingly increased, while the isolation rating of each individual machine segment 1225a, 1225b, and 1225c can remain substantially the same (e.g., 100V). Thus, the isolation rating of each machine segment 1225a, 1225b, and 1225c can be less than the system-level electrical insulator 1270. Moreover, the isolation rating of each individual machine segment 1225a, 1225b, and 1225c can be less than an insulating rating of a machine segment including a single converter or a machine segment forming substantially the entire stator (e.g., a non-segmented stator).

While the machine segments 1225a, 1225b, and 1225c are described above as being substantially similar to the machine segment 325 of FIG. 3, in other embodiments, the machine segments 1225a, 1225b, and 1225c can be any suitable arrangement. For example, while the machine segment 325 is described above as being associated with a single electrical phase, in some embodiments, the machine segments 1225a, 1225b, and 1225c can be associated with any number of phases, as described above with reference to the machine segments 425 of FIG. 4, 525 of FIG. 5, and 625 of FIG. 6. Furthermore, while the terminals of the machine segments 1225a, 1225b, and 1225c are shown as being, for example, a single electrical connection, in some embodiments where the machine segments 1225a, 1225b, and 1225c are multi-phase machine segments, the machine segments 1225a, 1225b, and 1225c can be electrically connected in any suitable manner including, for example, a wye configuration, a delta configuration, and/or the like.

Although the machine segments 1225a, 1225b, and 1225c are described above as being substantially similar to each other (e.g., having the same voltage rating, number of phases, etc.), in other embodiments, the first machine segment 1225a, the second machine segment 1225b, and the third machine segment 1225c can each have a different voltage rating and/or configuration. In such embodiments, the voltage rating and the isolation rating of each machine segment 1225a, 1225b, and 1225c can be independent of the remaining machine segments, while the voltage rating and the isolation rating, for example, of the electrical insulator 1270 can be increased or decreased accordingly. In addition, while the first machine segment 1225a is shown as being electrically connected to a ground, thereby electrically grounding the machine segments 1225a, 1225b, and 1225c collectively, in other embodiments, the machine segments 1225a, 1225b, and/or 1225c are not be electrically grounded. For example, in some embodiments, the second input/output or terminal (e.g., the negative terminal) of the first machine segment 1225a and the first input/output or terminal (e.g., the positive terminal) of the third machine segment 1225c can be electrically connected to an external electrical circuit, a load, and/or the like.

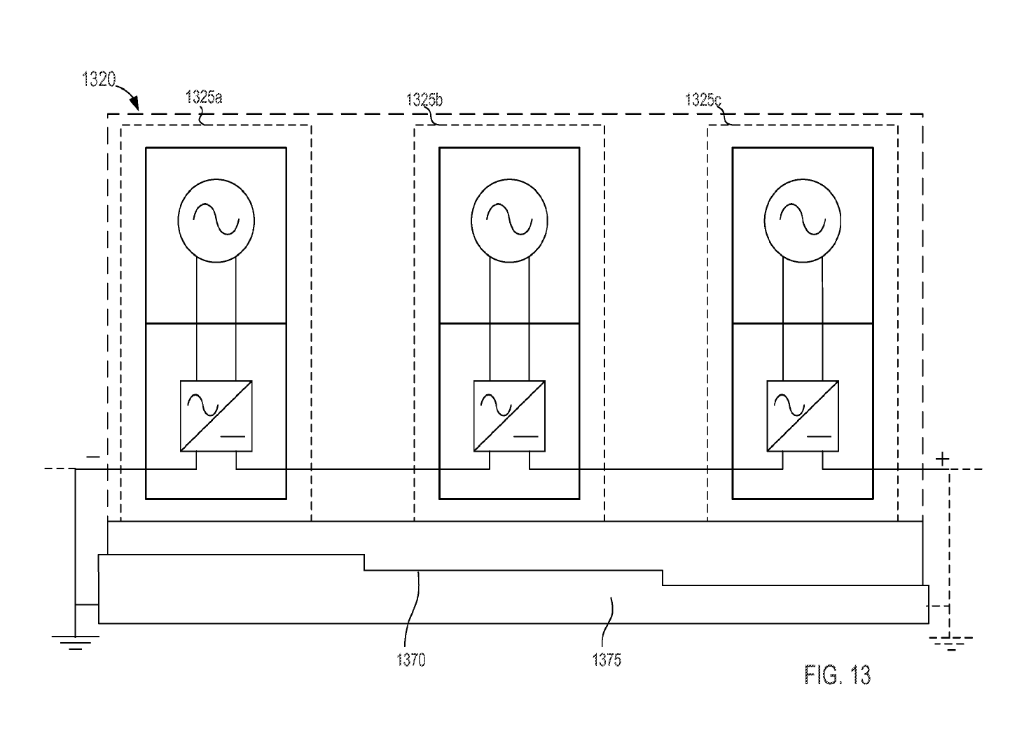

Although the electrical insulator 1270 is shown and described as being substantially continuous and/or homogeneous, in other embodiments, an electrical insulator can have a varied shaped, size, voltage rating, etc. along a length of, for example, a support structure. For example, FIG. 13 is a schematic illustration of a machine portion 1320 according to an embodiment. The machine portion 1320 can be a portion of an electromagnetic machine, and can be part of, for example, a stator assembly or a rotor assembly of the electromagnetic machine. The machine portion 1320 can be substantially similar to the machine portion 1220 described above. For example, the machine portion 1320 includes a first machine segment 1325a, a second machine segment 1325b, a third machine segment 1325c, an electrical insulator 1370, and a support structure 1375. The first machine segment 1325a, the second machine segment 1325b, and the third machine segment 1325c can be, for example, substantially similar to the first machine segment 1225a, the second machine segment 1225b, and the third machine segment 1225c described above with reference to FIG. 12. Moreover, the machine segments 1325a, 1325b, and 1325c can be electrically connected in series, as described above. Thus, similar aspects and/or arrangements of the machine segments 1325a, 1325b, and 1325c and/or the machine portion 1320 are not described in further detail herein.

The machine portion 1320 can differ from the machine portion 1220, however, in the arrangement of the electrical insulator 1370 and the support structure 1375. For example, in some embodiments, the machine segments 1325a, 1325b, and 1325c can each be 100V machine segments with a 100V isolation rating, as described above. As shown in FIG. 13, the arrangement of the electrical insulator 1370 (e.g., a system-level insulator) can be such that as a voltage accumulates along the machine segments 1325a, 1325b, and 1325c, machine segments 1325a, 1325b, and 1325c being electrically coupled in series, an isolation rating associated with the electrical insulator 1370 at the boundaries of machine segments 1325a, 1325b, and 1325c correspondingly increases. For example, the isolation rating of the electrical insulator 1370 can be increased by increasing a thickness of the electrical insulator 1370, introducing a material into the electrical insulator 1370 with a greater insulating strength, and/or via any other suitable manner. Thus, for example, a first portion of the electrical insulator 1370 corresponding to and/or associated with the boundary of the first machine segment 1335a can have an isolation rating of 100V, a second portion of the electrical insulator 1370 corresponding to and/or associated with the boundary of the second machine segment 1335b can have an isolation rating of 200V, and a third portion of the electrical insulator 1370 corresponding to and/or associated with the boundary of third machine segment 1335c can have an isolation rating of 300V, as shown in FIG. 13. Accordingly, as the overall voltage of the system increases with the serial arrangement of the machine segments 1325a, 1325b, and 1325c, the isolation rating of the electrical insulator 1370 can increase.

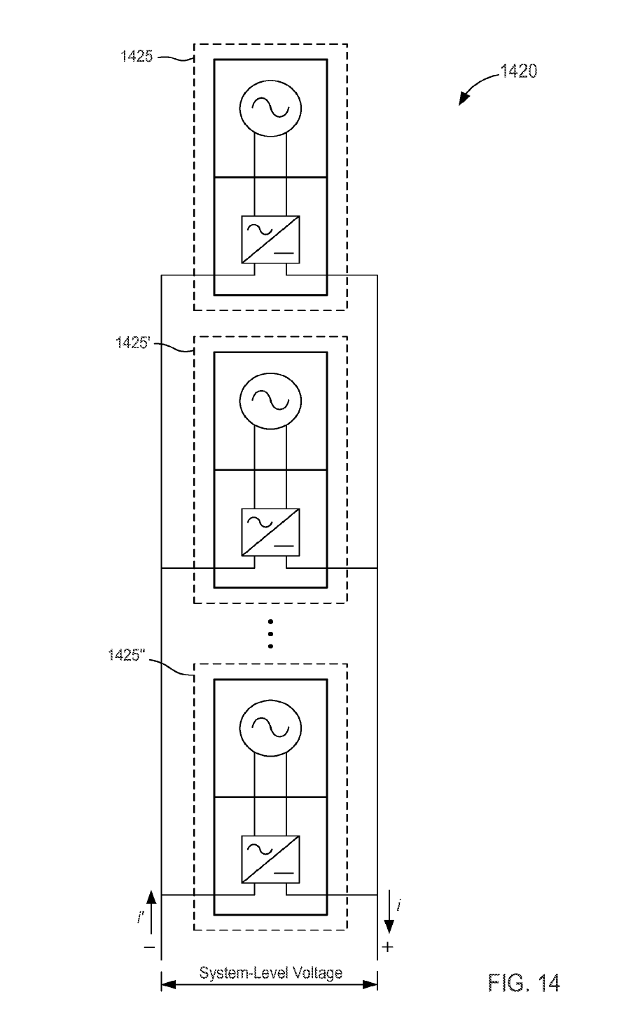

While the machine segments shown and described above with reference to FIGS. 12 and 13, are electrically connected in series, in other embodiments, any number of machine segments can be electrically connected, for example, in an electrical parallel configuration. For example, FIG. 14 is a schematic illustration of a portion of a machine portion 1420 according to an embodiment. The machine portion 1420 can be a portion of an electromagnetic machine, and can be part of, for example, a stator assembly or a rotor assembly of the electromagnetic machine. The machine portion 1420 can be substantially similar in form and/or function to, for example, the machine portion 220 described above with reference to FIG. 2. As shown, the machine portion 1420 includes at least a first machine segment 1425, a second machine segment 1425′, and a third machine segment 1425″ that are electrically connected in parallel. While shown as including three machine segments, the machine portion 1420 can include any number of machine segments, as indicated by the ellipsis in FIG. 14. The first machine segment 1425, the second machine segment 1425′, and the third machine segment 1425″ can be, for example, substantially similar to the machine segment 325 described above with reference to FIG. 3. Thus, similar aspects and/or arrangements of the machine segments 1425, 1425′, and 1425″ and/or the machine portion 1420 are not described in further detail herein.

The arrangement of the machine segments 1425, 1425′, and 1425″ in parallel can, in some instances, reduce a resistance, and/or impedance associated with an electrical circuit of the machine portion 1420. In this manner, a system-level current (e.g., AC, indicated as i and i′, in FIG. 14) that flows through the machine segments 1425, 1425′, and 1425″ and/or through the electrical circuit of the machine portion 1420 can be increased, thus resulting in an increased electric power output. In some instances, the system-level current i at a first input/output or terminal (e.g., a positive terminal) can be different then the system-level current i′ at a second input/output or terminal due to, for example, electrical filtering, short circuit, and/or the like. In other instances, the system-level current i at a first input/output or terminal (e.g., a positive terminal) can be substantially the same as the system-level current i′ at a second input/output or terminal.

In some embodiments, with the machine segments 1425, 1425′, and 1425″ electrically connected in parallel, a potential voltage across a first input/output or terminal (e.g., a positive terminal) and a second input/output or terminal (e.g., a negative terminal) of each machine segment 1425, 1425′, and 1425″ can be substantially the same as across the input/output terminals of the other machine segments 1425, 1425′, and 1425″. As such, in some instances, an amount of electric isolation can be reduced between the machine segments 1425, and 1425′, and 1425″ due, at least in part, to a voltage stress (i.e., a difference in voltage) therebetween being substantially zero. In addition, by arranging the machine segments 1425, 1425′, and 1425″ in parallel, the stability of the electrical circuit of the machine portion 1420 can be increased (e.g., a fault condition in one of the machine segments 1425, 1425′, or 1425″ does not prevent a flow of current through the rest of the electrical circuit). As such, the parallel arrangement of the machine segments 1425, 1425′, and 1425″ can add a desired redundancy to the machine portion 1420. In some instances, the modular arrangement of the machine segments 1425, 1425′, and 1425″ can be such that an inductance of the electric field induced by, for example, the movement of a magnetic field past machine windings of each machine winding 1425, 1425′, and 1425″ does not substantially affect the inductance of the remaining machine segments 1425, 1425′, and 1425″.

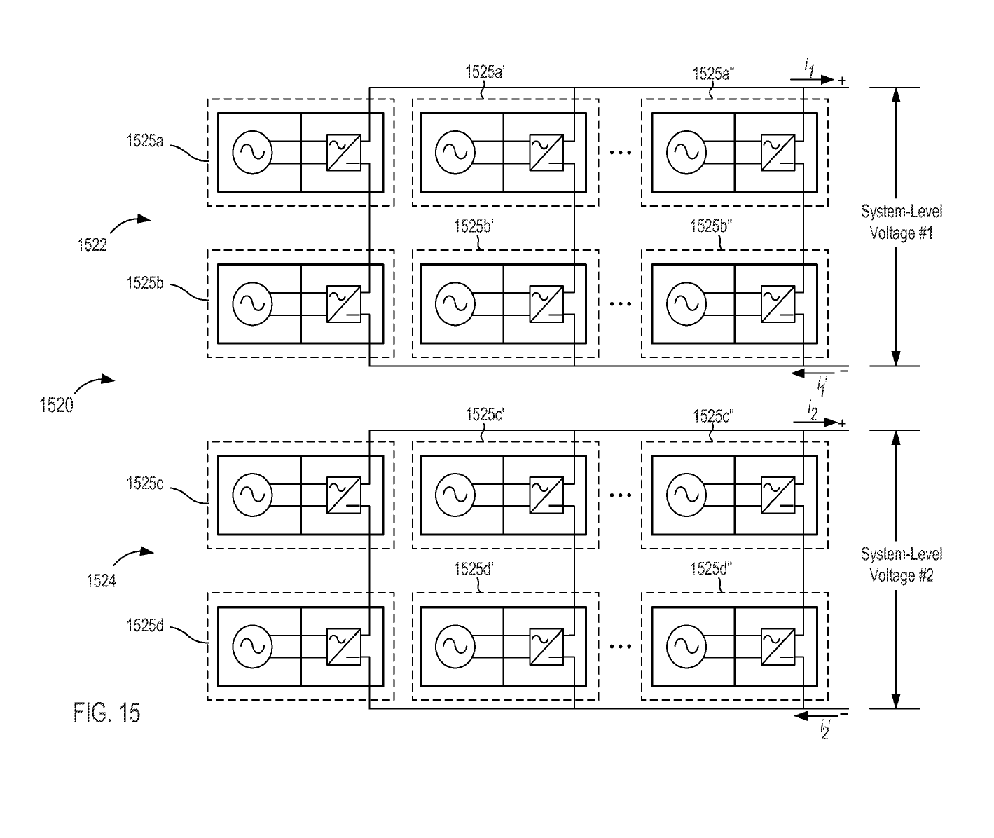

While the stator assemblies 1220 (FIG. 12), 1320 (FIG. 13), and 1420 (FIG. 14), are shown and described as including machine segments that are electrically coupled uniformly in a series configuration or a parallel configuration, in other embodiments, an electromagnetic machine can include any number of machine segments, which are electrically connected in both series and parallel. For example, FIG. 15 is a schematic illustration of a portion of a machine portion 1520 according to an embodiment. The machine portion 1520 can be a portion of an electromagnetic machine, and can be part of, for example, a stator assembly or a rotor assembly of the electromagnetic machine. The machine portion 1520 can be substantially similar in form and/or function, for example, the machine portion 220 described above with reference to FIG. 2.

As shown, the machine portion 1520 can include a first subassembly of machine segments 1522 (referred to henceforth as “first subassembly”) and a second subassembly of machine segments 1524 (referred to henceforth as “second subassembly”). The first subassembly 1522 includes, for example, six machine segments 1525a, 1525a′, 1525a″, 1525b, 1525b′, and 1525b″. As shown, the machine segments 1525a and 1525b are electrically connected in series (as described above with reference to FIGS. 12 and 13). Similarly, the machine segments 1525a′ and 1525b′ as well as the machine segments 1525a″ and 1525b″ are also electrically connected in series. The machine segments 1525a and 1525b are collectively coupled in electric parallel (as described above with reference to FIG. 14) to the machine segments 1525a′ and 1525b′, which in turn, are collectively coupled in electric parallel to the machine segments 1525a″ and 1525b″. In this manner, the first subassembly 1522 can be configured to produce a first system-level voltage. Moreover, the first system-level voltage and/or system-level current can be increased or decreased by arranging the machine segments 1525a, 1525a′, 1525a″, 1525b, 1525b′, and 1525b″ in a different configuration of series and parallel connections.

In some embodiments, with the serially connected machine segments 1525a and 1525b, 1525a′ and 1525b′, and 1525a″ and 1525b″, electrically connected in parallel, a potential voltage across a first input/output or terminal (e.g., a positive terminal) of each serially connected machine segment pair and a second input/output or terminal (e.g., a negative terminal) of each serially connected machine segment pair can be substantially the same. In this manner, a system-level current (e.g., AC, indicated as i₁ and i₁′, in FIG. 15) that flows through the first subassembly 1522 can be increased, thus resulting in an increased electric power output. In some instances, the system-level current i₁ at a first input/output or terminal can be the same or can be different then the system-level current i₁′ at a second input/output or terminal, as described above with reference to the machine portion 1420 in FIG. 14.

The second subassembly 1524 includes, for example, six machine segments 1525c, 1525c′, 1525c″, 1525d, 1525d′, and 1525d″ that are arranged in a substantially similar manner as described above with the first subassembly 1522. In this manner, the second subassembly 1524 can be configured to produce a second system-level voltage. Moreover, the second system-level voltage and/or system-level current can be increased or decreased by arranging the machine segments 1525c, 1525c′, 1525c″, 1525d, 1525d′, and 1525d″ in a different configuration of series and parallel connections. In some embodiments, the arrangement of the machine portion 1520 can be such that the first system-level voltage and the second system-level voltage are substantially the same. In other embodiments, the arrangement of the series and/or parallel connections included in the first subassembly 1522 or the arrangement of the series and/or parallel connections included in the second subassembly 1524 can be modified such that the first system-level voltage and the second system-level voltage are substantially different. Moreover, as described above, the system-level current i₂ at a first input/output or terminal can be the substantially same or can be different then the system-level current i₂′ at a second input/output or terminal, as described above with reference to the first subassembly 1522. Additionally, the system-level current i₂ and i₂′ of the second subassembly 1524 can be substantially the same as the system-level current i₁ and i₁′, respectively, of the first subassembly 1522.

Although the first subassembly 1522 and the second subassembly 1524 are shown and described as each including six machine segments, in other embodiments, the first subassembly 1522 and/or the second subassembly 1524 can include any number of machine segments (as indicated by the ellipsis in FIG. 15). Moreover, the additional machine segments can be electrically connected in series and/or parallel. In some embodiments, a pair of serially connected machine segments can be added to the first subassembly 1522 and/or the second subassembly 1524 and can collectively be coupled to the machine segments of the first subassembly 1522 or the second subassembly 1524 in a parallel connection. Thus, for example, symmetry of the first subassembly 1522 and/or the second subassembly 1524 can be maintained. In some embodiments, the first subassembly 1522 and the second subassembly 1524 can be disposed in the same electromagnetic machine (e.g., a generator or a motor) and electrically connected to different loads. As such the machine portion 1520 can maintain the first subassembly 1522 and the second subassembly 1524 in electrical isolation relative to one another, while being part of a common electromagnetic machine.

Although the first subassembly 1522 and the second subassembly 1524 are described herein as being operated as a generator (i.e., electrical power is induced in a machine winding by moving a magnetic field relative thereto and delivered to a converter), in other embodiments, the first subassembly 1522 and/or the second subassembly 1524 can be operated as a motor (i.e., electrical power or current is delivered to a machine winding (e.g., from a converter or external source) and a resulting electrical field in the machine windings rotates, for example, a rotor. In some instance, the first subassembly 1522 can be operated as a generator while the second subassembly 1524 is operated as a motor (or vice versa). In some such instances, a controller (such as the controller 780) and/or the like included in the first subassembly 1522 and/or the second subassembly 1524 can control and/or otherwise be operable in switching a mode of operation (i.e., as a generator or as a motor) of the first subassembly 1522 and/or the second subassembly 1524 in response to an operating condition such as, for example, a fault condition, a thermal condition, mechanical vibration, load and/or source balancing, and/or the like. In other instances, a system-level controller can control and/or otherwise be operable in switching the mode of operation of the first subassembly 1522 and/or the second subassembly 1524. In some instances, an operating mode of any of the machine segments 1525a, 1525a′, 1525a″, 1525b, 1525b′, and/or 1525b″ included in the first subassembly 1522 can be switched independently of the remaining machine segments of the first subassembly 1522. Similarly, an operating mode of any of the machine segments 1525c, 1525c′, 1525c″, 1525d, 1525d′, and/or 1525d″ included in the second subassembly 1524 can be switched independently of the remaining machine segments of the first subassembly 1524.

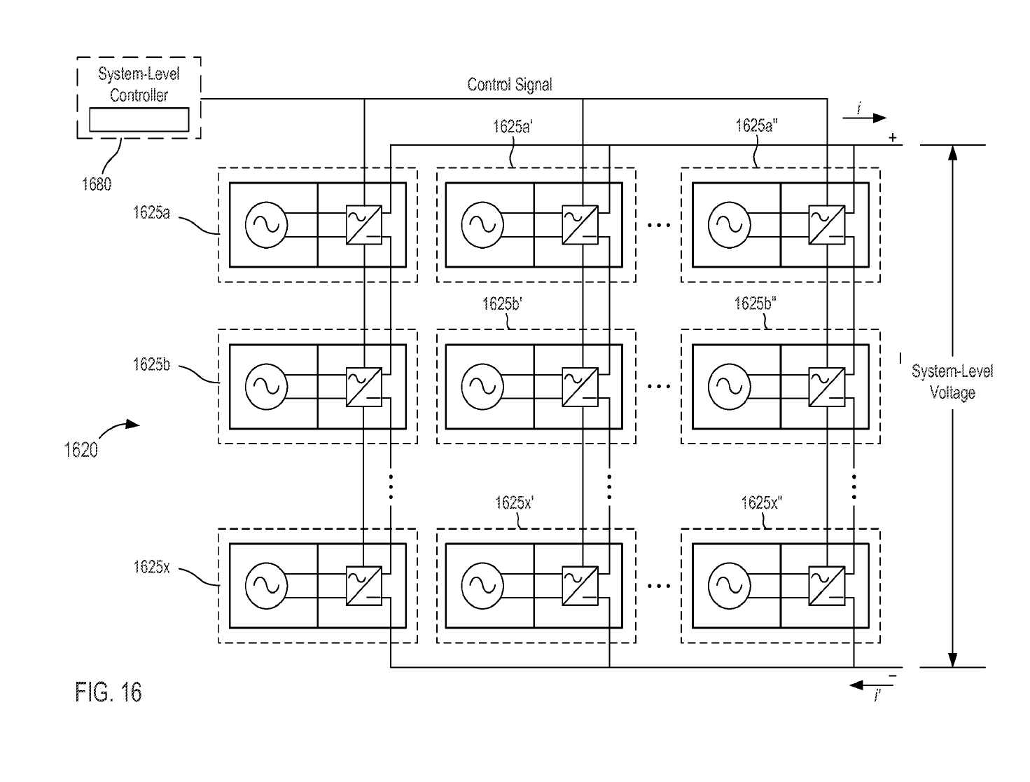

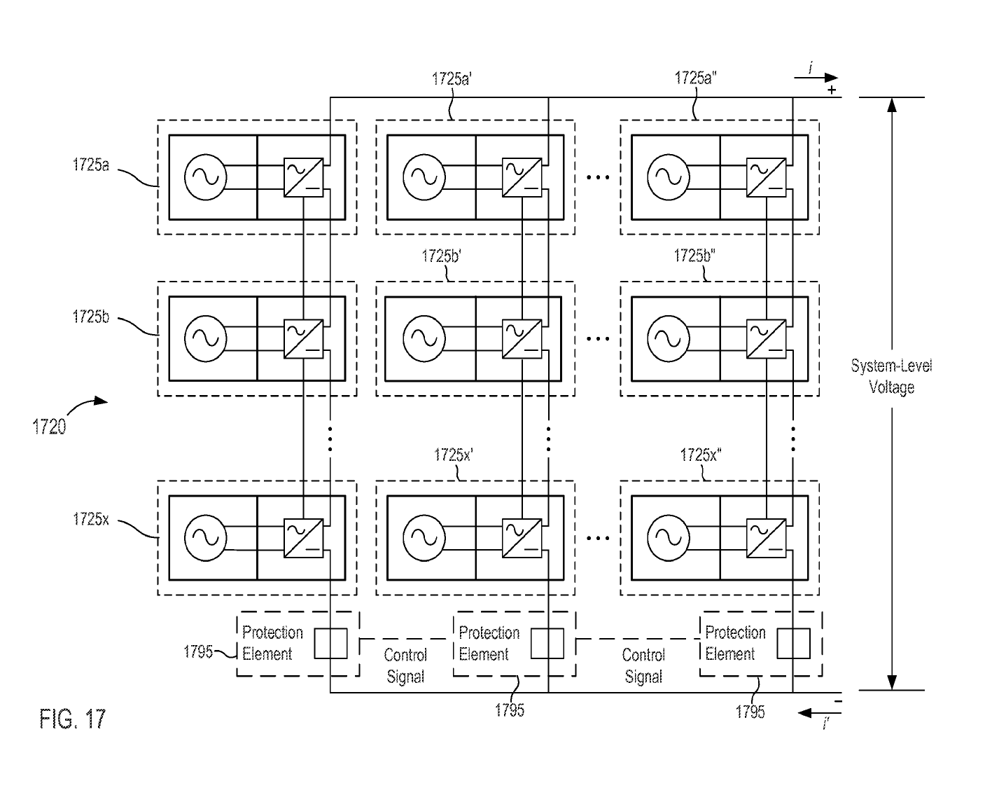

FIG. 16 is a schematic illustration of a portion of a machine portion 1620 according to an embodiment. The machine portion 1620 can be a portion of an electromagnetic machine, and can be part of, for example, a stator assembly or a rotor assembly of the electromagnetic machine. The machine portion 1620 can be substantially similar in form and/or function to, for example, the machine portion 220 described above with reference to FIG. 2. As shown, the machine portion 1620 can include any number of machine segments that can be arranged in both series and parallel configurations. More specifically, the machine portion 1620 can include, for example, nine machine segments 1625a, 1625a′, 1625a″, 1625b, 1625b′, 1625b″, 1625x, 1625x′, and 1625x″. Although the machine portion 1620 is shown and described as each including nine machine segments, in other embodiments, the machine portion 1620 can include any number of machine segments (as indicated by the ellipsis in FIG. 16 and the letter “x”). As shown, the machine segments 1625a, 1625b, and 1625x are electrically connected in series (as described above with reference to FIG. 15). More specifically, the machine portion 1620 can include more than nine similarly arranged machine segments with, for example, the machine segments 1625a-1625x electrically connected in series. Similarly, the machine segments 1625a′, 1625b′, and 1626x″ as well as the machine segments 1625a″, 1625b″, and 1625x″ are also electrically connected in series. The machine segments 1625a, 1625b, 1625x are collectively coupled in electric parallel (as described above with reference to FIG. 14) to the machine segments 1625a′, 1625b′, and 1625x″, which in turn, are collectively coupled in electric parallel to the machine segments 1625a″, 1625b″, 1625x″. In this manner, the machine portion 1620 can be configured to produce a system-level voltage. Moreover, the system-level voltage and/or system-level current (as indicated by the arrows i and i′ in FIG. 16) can be increased or decreased by arranging the machine segments 1625a, 1625a′, 1625a″, 1625b, 1625b′, 1625b″, 1625x, 1625x′, and 1625x″ in a different configuration of series and parallel connections, as described in detail above with reference to the machine portion 1520 of FIG. 15. In some instances, the system-level current i at a first input/output or terminal (e.g., a positive terminal) can be different then the system-level current i′ at a second input/output or terminal due to, for example, electrical filtering, short circuit, and/or the like. In other instances, the system-level current i at a first input/output or terminal (e.g., a positive terminal) can be substantially the same as the system-level current i′ at a second input/output or terminal.

As shown in FIG. 16, the machine portion 1620 also includes a system-level controller 1680 (referred to henceforth as “controller”). The controller 1680 can be any suitable control circuit or the like. For example, in some embodiments, the controller 1680 can include any number of insulated-gate bipolar transistors (IGBT), metal-oxide semiconductor field-effect transistors (MOSFET), and/or the like. In some instances, the controller 1680 can be a proportional-integral-derivative (PID) controller, programmable logic controller (PLC) and/or the like. The controller 1680 can, for instance, respond to at least one of an instruction programmed in the controller 1680, a signal or instruction sent to the controller 1680, a signal or instruction detected in at least one of the machine segments from 1625a, 1625a′, 1625a″, 1625b, 1625b′, 1625b″, 1625x, 1625x′, and 1625x″, or a signal or instruction delivered to at least one of the machine segments from 1625a, 1625a′, 1625a″, 1625b, 1625b′, 1625b″, 1625x, 1625x′, and 1625x″. In this manner, the controller 1680 can substantially control the operation of portions of the machine portion 1620 and/or any one or more of the machine segments 1625a, 1625a′, 1625a″, 1625b, 1625b′, 1625b″, 1625x, 1625x′, and 1625x″. More particularly, the controller 1680 can send a control signal that can include instructions for and/or otherwise result in, for example, normal operation of the machine segment 1625a, 1625a′, 1625a″, 1625b, 1625b′, 1625b″, 1625x, 1625x′, and/or 1625x″, and/or higher-level control of the system such as, load balancing, voltage balancing, synchronization between machine segments, or fault response. As shown in FIG. 16, the controller 1680 can be configured to communicate (e.g., via a wired or wireless connection) with at least one machine segment, such that a signal can be transmitted to and/or from the at least one machine segment. In some embodiments, the controller 1680 can be configured to communicate with, for example, a controller included in at least one machine segment from 1625a, 1625a′, 1625a″, 1625b, 1625b′, 1625b″, 1625x, 1625x′, and 1625x″. In such embodiments, the system-level controller and the controller of at least one machine segment from 1625a, 1625a′, 1625a″, 1625b, 1625b′, 1625b″, 1625x, 1625x′, and 1625x″ can be collectively configured to control the operation of the system such as, for example, load balancing, voltage balancing, synchronization between machine segments, or fault response. In some other embodiments, the controller can substantially control the operation of at least one machine segment from 1625a, 1625a′, 1625a″, 1625b, 1625b′, 1625b″, 1625x, 1625x′, and 1625x″ directly, without requiring that the at least one machine segment from 1625a, 1625a′, 1625a″, 1625b, 1625b′, 1625b″, 1625x, 1625x′, and 1625x″ also include a machine segment controller.

While machine portion 1620 is shown and described above as including the system-level controller 1680, in other embodiments, a machine portion can include any suitable system-level device or the like. For example, FIG. 17 is a schematic illustration of a portion of a machine portion 1720 according to an embodiment. The machine portion 1720 can be a portion of an electromagnetic machine, and can be part of, for example, a stator assembly or a rotor assembly of the electromagnetic machine. The machine portion 1720 can be substantially similar in form and/or function to, for example, the machine portion 220 described above with reference to FIG. 2. As shown, the machine portion 1720 can include any number of machine segments that can be arranged in both series and parallel configurations. More specifically, the machine portion 1720 includes, for example, nine machine segments 1725a, 1725a′, 1725a″, 1725b, 1725b′, 1725b″, 1725x, 1725x′, and 1725x″. Although the machine portion 1720 is shown and described as each including nine machine segments, in other embodiments, the machine portion 1720 can include any number of machine segments (as indicated by the ellipsis in FIG. 17 and the letter “x”). As shown, the machine segments 1725a, 1725b, and 1725x are electrically connected in series (as described above with reference to FIG. 15). More specifically, the machine portion 1720 can include more than nine similarly arranged machine segments with, for example, the machine segments 1725a-1725x electrically connected in series. Similarly, the machine segments 1725a′, 1725b′, and 1726x″ as well as the machine segments 1725a″, 1725b″, and 1725x″ are also electrically connected in series. The machine segments 1725a, 1725b, 1725x are collectively coupled in electric parallel (as described above with reference to FIG. 14) to the machine segments 1725a′, 1725b′, and 1725x″, which in turn, are collectively coupled in electric parallel to the machine segments 1725a″, 1725b″, 1725x″. In this manner, the machine portion 1720 can be configured to produce a system-level voltage and/or current. Moreover, the system-level voltage and/or system-level current (as indicated by the arrows i and i′ in FIG. 17) can be increased or decreased by arranging the machine segments 1725a, 1725a′, 1725a″, 1725b, 1725b′, 1725b″, 1725x, 1725x′, and 1725x″ in a different configuration of series and parallel connections, as described in detail above with reference to the machine portion 1520 of FIG. 15. In some instances, the system-level current i at a first input/output or terminal (e.g., a positive terminal) can be different then the system-level current i′ at a second input/output or terminal due to, for example, electrical filtering, short circuit, and/or the like. In other instances, the system-level current i at a first input/output or terminal (e.g., a positive terminal) can be substantially the same as the system-level current i′ at a second input/output or terminal.

As shown in FIG. 17, the machine portion 1720 also includes a set of protection elements 1795. More specifically, for each set of machine segments electrically connected in series (e.g., 1725a, 1725b, and 1725x), the machine portion 1720 can include a protection element 1795 electrically connected thereto in series. In other embodiments, the machine portion 1720 can include a protection element 1795 serially connected between each machine segment 1725a, 1725a′, 1725a″, 1725b, 1725b′, 1725b″, 1725x, 1725x′, and 1725x″. The protection element 1795 can be any suitable device, mechanism, element, and/or the like that can be configured to, for example, reduce, limit, and/or block a current and/or voltage through any of portion of the electrical circuit included in the machine portion 1720. For example, in some embodiments, the protection elements 1795 can be any suitable device or circuit such as, a fuse, a circuit breaker, a switch, and/or the like. In some embodiments, the protection elements 1795 can be and/or can include, for example, IGBTs, MOSFETs, and/or any other suitable devices that can be controlled, for example, by a controller and/or a control signal (e.g., the controlled by the system-level controller 1680 of FIG. 16). In some embodiments, the protection element 1795 can be substantially similar to or the same as those described above with reference to the protection element 785 in FIG. 7.

In some embodiments, the protection elements 1795 can be “initiated” (e.g., tripped, blown, broken, and/or otherwise transitioned from a first state to a second state) based at least in part on reaching, for example, a predetermined limit on such characteristics as voltage, current, operating temperature, mechanical load, and/or the like. In addition, in some embodiments, the protection elements 1795 can be configured to send a signal to and/or receive a signal from (e.g., via a wired or wireless communication) the remaining protection elements 1795, a controller, and/or any other suitable device operably coupled thereto to provide a coordinated fault response between, for example, multiple machine segments. In some embodiments, the protection elements 1795 can be configured to electrically isolate and/or remove a set of machine segments (e.g., one or more) from the electrical circuit of the machine portion 1720 when an electrical state of that set of machine segments results in the protection elements 1795 being initiated. For example, in some embodiments, the protection elements 1795 can be configured to remove a branch of machine segments that are electrically connected in series such that the branch of machine segments is electrically isolated from the remaining machine segments (e.g., branches of machines segments that are in series and to which the electrically isolated branch of machine segments is electrically connected in parallel).

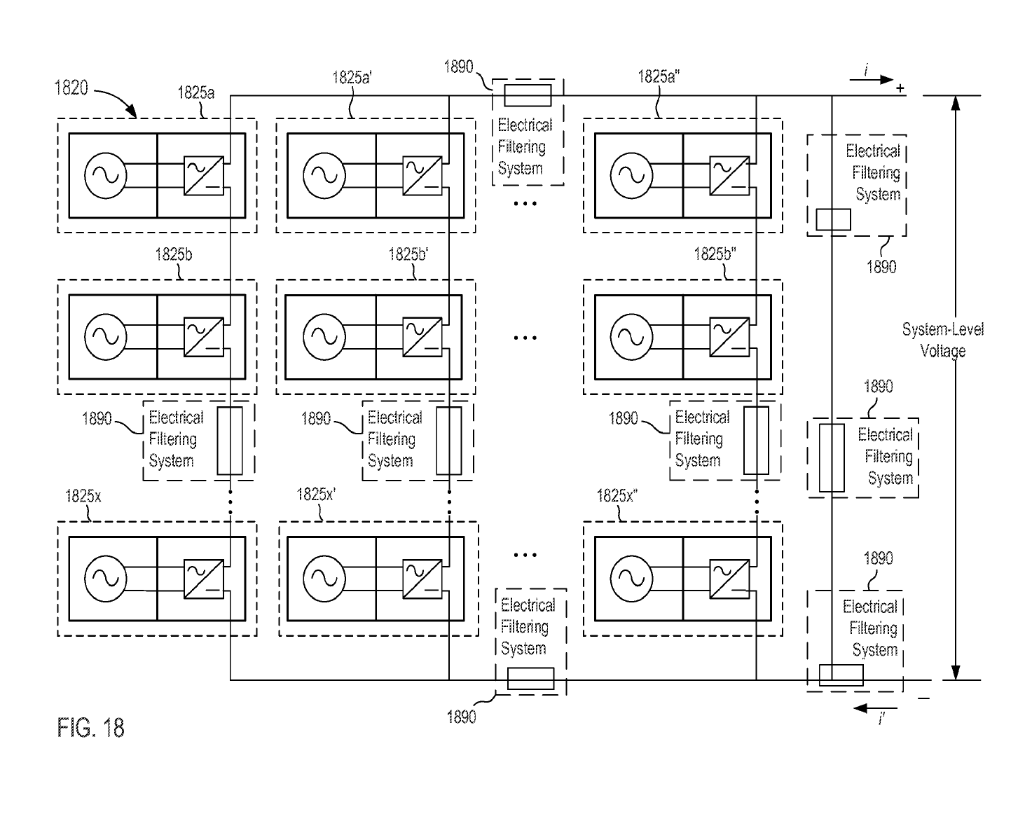

While machine portion 1720 is shown and described above as including the set of protection elements 1795, in other embodiments, a machine portion can include any suitable system-level device or the like. For example, FIG. 18 is a schematic illustration of a portion of a machine portion according to an embodiment. The machine portion 1820 can be a portion of an electromagnetic machine, and can be part of, for example, a stator assembly or a rotor assembly of the electromagnetic machine. The machine portion 1820 can be substantially similar in form and/or function to, for example, the machine portion 220 described above with reference to FIG. 2. As shown, the machine portion 1820 can include any number of machine segments 1822 that can be arranged in both series and parallel configurations. More specifically, the machine portion 1820 includes, for example, nine machine segments 1825a, 1825a′, 1825a″, 1825b, 1825b′, 1825b″, 1825x, 1825x′, and 1825x″. Although the machine portion 1820 is shown and described as each including nine machine segments, in other embodiments, the machine portion 1820 can include any number of machine segments (as indicated by the ellipsis in FIG. 18 and the letter “x”). As shown, the machine segments 1825a, 1825b, and 1825x are electrically connected in series (as described above with reference to FIG. 15). More specifically, the machine portion 1620 can include more than nine similarly arranged machine segments with, for example, the machine segments 1825a-1825x electrically connected in series. Similarly, the machine segments 1825a′, 1825b′, and 1826x″ as well as the machine segments 1825a″, 1825b″, and 1825x″ are also electrically connected in series. The machine segments 1825a, 1825b, 1825x are collectively coupled in electric parallel (as described above with reference to FIG. 14) to the machine segments 1825a′, 1825b′, and 1825x″, which in turn, are collectively coupled in electric parallel to the machine segments 1825a″, 1825b″, 1825x″. In this manner, the machine portion 1820 can be configured to produce a system-level voltage and/or current. Moreover, the system-level voltage and/or system-level current (as indicated by the arrows i and i′ in FIG. 18) can be increased or decreased by arranging the machine segments 1825a, 1825a′, 1825a″, 1825b, 1825b′, 1825b″, 1825x, 1825x′, and 1825x″ in a different configuration of series and parallel connections, as described in detail above with reference to the machine portion 1520 of FIG. 15. In some instances, the system-level current i at a first input/output or terminal (e.g., a positive terminal) can be different then the system-level current i′ at a second input/output or terminal due to, for example, electrical filtering, short circuit, and/or the like. In other instances, the system-level current i at a first input/output or terminal (e.g., a positive terminal) can be substantially the same as the system-level current i′ at a second input/output or terminal.

As shown in FIG. 18, the machine segment 1825 also includes a set of electrical filtering elements 1890. The electrical filtering elements 1890 can be any suitable device, mechanism, element, and/or the like that can be configured to, for example, improve one or more characteristics associated with a flow of an electrical power and/or current through the machine portion 1820, such as a reduction of unwanted harmonic content. For example, in some embodiments, the electrical filtering elements 1890 can be substantially passive elements including, for example, inductors, capacitors, and/or the like. In other embodiments, the electrical filtering elements 1890 can be substantially active elements including, for example, filtering circuits, IGBTs, MOSFETs, and/or the like. In some embodiments, the electrical filtering elements 1890 can be substantially similar. The machine portion 1820 can include any number of electrical filtering elements 1890 that are electrically connected in series between any or all of the machine segments 1825a, 1825a′, 1825a″, 1825b, 1825b′, 1825b″, 1825x, 1825x′, and 1825x″. Thus, a flow of current (e.g., AC or DC) can be filtered prior to passing to a converter of each machine segment 1825a, 1825a′, 1825a″, 1825b, 1825b′, 1825b″, 1825x, 1825x′, and 1825x″. Said another way, a flow of current can be filtered after passing from the converter of each machine segment 1825a, 1825a′, 1825a″, 1825b, 1825b′, 1825b″, 1825x, 1825x′, and 1825x″. In addition, in some embodiments, the electrical filtering elements 1890 can be configured to send a signal to and/or receive a signal (e.g., via a wired or wireless communication) from the remaining electrical filtering elements 1890, a controller, and/or any other suitable device operably coupled thereto to provide a coordinated filtering of a flow of current (e.g., AC or DC) through the machine portion 1820.

While the embodiments have been described above with respect to laminated composite assemblies that form a segment of a segmented stator, in other embodiments, a laminated composite assembly such as those described herein can form a segment of a segmented rotor. In other embodiments, the machine segment need not be physically and/or electrically coupled to similar or corresponding machine segments. That is to say, in some embodiments, a machine segment can form substantially an entire portion of an electromagnetic machine such as, for example, substantially the entire stator or substantially the entire rotor.

While the embodiments have been described above as including machine windings that are, for example, etched on a conductive surface of a laminated composite assembly, in other embodiment, the machine segments, as described herein, can be included in and/or can form stator segments and/or windings of other electrical constructs. For example, the machine windings described herein can be wire-wound windings, iron-core windings, and/or the like, which can also define and/or can be aligned in one or more conductive layers.

While various embodiments have been described above, it should be understood that they have been presented by way of example only, and not limitation. Where methods and/or schematics described above indicate certain events and/or flow patterns occurring in certain order, the ordering of certain events and/or flow patterns can be modified. While the embodiments have been particularly shown and described, it will be understood that various changes in form and details can be made. For example, although the embodiments have been particularly described above as being arranged in a given electrical configuration, in other embodiments, any of the components, devices, assemblies, subassemblies, etc. can be electrically connected in any suitable manner. More specifically, while components of some of the embodiments have been described above as being electrically connected in either a series or a parallel configuration, in other embodiments, any of the components can be electrically connected in any suitable manner (i.e., series or parallel). Similarly, while embodiments have been described above as being electrically connected in a star configuration, a wye configuration, a delta configuration, and/or the like, in other embodiments, such electrical connections can be any suitable configuration.

Although various embodiments have been described as having particular features and/or combinations of components, other embodiments are possible having a combination of any features and/or components from any of embodiments as discussed above. For example, while the machine segments 725, 825, 925, 1025, and 1125 have been shown and described above (with reference to FIGS. 7-11, respectively) as including the controller 780, the heat rejection system 885, the filtering element 990, the protection element 995, and the EMI shield 1198, respectively, in other embodiments, any of the machine segments described herein can include any combination of a controller, a heat rejection system, a filtering element, a protection element, and/or an EMI shield. Similarly, while the stator assemblies 1680, 1780, and 1880 have been shown and described above (with reference to FIGS. 16-18, respectively) as including the controller 1680, the protection elements 1795, and the filtering elements 1890, in other embodiments, any of the stator assemblies described herein can include a combination of any combination of a controller, a heat rejection system, a filtering element, a protection element, and/or an EMI shield.

While the machine segments have been shown and described above as being electrically coupled to form the segmented stator, in some embodiments, the machine segments can also be physically and/or mechanically coupled to each other to form the segmented stator. Similarly stated, the machine segments can be physically and electrically coupled to each other to form the segmented stator. In some embodiments, the machine segments described herein can have a size and/or shape that is associated with a portion of the segmented stator of which it is a part. For example, in some embodiments, the machine segments described herein can have a substantially arced-shape such that, when coupled together, the machine segments form a substantially annular segmented stator. In other embodiments, the machine segments can have any other suitable shape and/or size to form a stator or rotor. Moreover, the modular arrangement of the machine segments, as described herein, can be such that the machine segments are removably coupled (e.g., physically and electrically).

While generally described above as forming a segmented stator, in other embodiments, the machine segments can be electrically and/or mechanically coupled to form a segmented rotor. Such a segmented rotor can be arranged structurally and/or functionally similar to the segmented stators described herein. Furthermore, although the embodiments described above generally refer to a machine segment being configured to share a moving body of a machine, such as a shared rotor, in other embodiments a machine segment having a machine winding on a moving body can have a shared stationary body, such as a shared stator. In yet other embodiments, a machine segment can include a machine winding on a moving body, and also share a moving body of the machine. Said another way, a machine winding and a shared body of the machine can have any manner of relative motion, such that the machine winding and shared body of the machine are collectively configured to convert between power in the substantially AC electrical state and power in the substantially mechanical state.

What is claimed is:

1. An apparatus, comprising:
a machine segment from a plurality of machine segments configured to have a shared moving body, the machine segment configured to be associated with a portion of a power of a machine formed by the plurality of machine segments and the shared moving body,
the machine segment having a first portion including an electrically conductive machine winding, the first portion and the shared moving body collectively configured to convert power between a substantially mechanical state and a substantially alternating current (AC) electrical state,
the machine segment having a second portion including a power converter electrically coupled to the electrically conductive machine winding, the power converter configured to convert power between the substantially AC electrical state and a substantially direct current (DC) electrical state,
the second portion including a first electrical terminal and a second electrical terminal configured to be electrically coupled to an external electrical circuit, the first electrical terminal and the second electrical terminal collectively configured to transfer power in the substantially DC electrical state between the power converter and the external electrical circuit,
the machine segment being electrically removably coupled to the external electrical circuit at a location substantially defined by the first electrical terminal and the second electrical terminal,
the machine segment being mechanically removably coupled to the remaining machine segments from the plurality of machine segments.

2. The apparatus of claim 1, wherein the power converter is configured to receive power from the external electrical circuit in the substantially DC electrical state, the power converter is configured to convert the power received from the external electrical circuit to the substantially AC electrical state,
the electrically conductive machine winding configured to receive the power in the substantially AC electrical state from the power converter, the electrically conductive machine winding and the shared moving body are collectively configured to convert the power received in the substantially AC electrical state to power in the substantially mechanical state, such that the machine segment operates as a motor.

3. The apparatus of claim 1, wherein the shared moving body is configured to receive power in the substantially mechanical state, the shared moving body and the electrically conductive machine winding are collectively configured to convert the power received in the substantially mechanical state to the substantially AC electrical state,
the power converter is configured to receive the power in the substantially AC electrical state from the electrically conductive machine winding and convert the power in the substantially AC electrical state to power in the substantially DC electrical state, such that the machine segment operates as a generator.

4. The apparatus of claim 1, wherein the machine segment is configured to operate in a first mode during a first time period, the machine segment configured to operate in a second mode during a second time period different than the first time period,
when the machine segment is in the first mode:
the power converter is configured to receive power from the external electrical circuit in the substantially DC electrical state, the power converter is configured to convert the power received from the external electrical circuit to the substantially AC electrical state,
the electrically conductive machine winding is configured to receive the power in the substantially AC electrical state from the power converter, and the electrically conductive machine winding and the shared moving body are collectively configured to convert the power received in the substantially AC electrical state to power in the substantially mechanical state, such that the machine segment operates as a motor,
when the machine segment is in the second mode:
the shared moving body is configured to receive power in the substantially mechanical state, the shared moving body and the electrically conductive machine winding are collectively configured to convert the power received in the substantially mechanical state to the substantially AC electrical state,
the power converter is configured to receive the power in the substantially AC electrical state from the electrically conductive machine winding and convert the power received in the substantially AC electrical state to power in the substantially DC electrical state, such that the machine segment operates as a generator.

5. The apparatus of claim 1, wherein the power in the substantially AC electrical state is associated with a plurality of electrical phases.

6. The apparatus of claim 1, wherein the electrically conductive machine winding includes a plurality of phase windings, each phase winding from the plurality of phase windings being (1) associated with a different electrical phase from a plurality of electrical phases and (2) having a terminal at a first end portion of that phase winding and a terminal at a second end portion of that phase winding,
the terminal at the first end portion of each phase winding from the plurality of phase windings being operatively coupled to the power converter via a connector different than a connector operatively coupling the terminal at the second end portion of that phase winding from the plurality of phase windings to the power converter.

7. The apparatus of claim 1, further comprising a controller operatively coupled to the machine segment, the controller configured to at least partially control the operation of at least a portion of the machine segment in response to at least one of an instruction programmed in the controller, a signal detected within the machine segment, or a signal delivered to the machine segment.

8. The apparatus of claim 1, further comprising an electrical filtering element operatively coupled to the machine segment, the electrical filtering element configured to modify a characteristic of at least one of the power substantially in the AC electrical state or the power substantially in the DC electrical state.

9. The apparatus of claim 1, further comprising a protection element operatively coupled to the machine segment, the protection element configured to reduce at least one of a voltage or a current in a portion of the machine segment in response to a fault condition.

10. A system, comprising:
a plurality of machine segments, each machine segment from the plurality of machine segments configured to share a moving body of an electromagnetic machine,
each machine segment from the plurality of machine segments configured to be associated with a portion of a total power of the electromagnetic machine,
each machine segment from the plurality of machine segments having a first portion including an electrically conductive machine winding, the electrically conductive machine winding of the first portion of each machine segment from the plurality of machine segments and the moving body collectively configured to convert power between a substantially mechanical state and a substantially alternating current (AC) electrical state,
each machine segment from the plurality of machine segments having a second portion including a power converter electrically coupled to the electrically conductive machine winding of the first portion of that machine segment, the power converter of each machine segment from the plurality of machine segments configured to convert power between the substantially AC electrical state and a substantially direct current (DC) electrical state,
the second portion of each machine segment from the plurality of machine segments including a plurality of electrical terminals, an electrical terminal from the plurality of electrical terminals of a first machine segment from the plurality of machine segments configured to be electrically connected to an electrical terminal from the plurality of electrical terminals of a second machine segment from the plurality of machine segments such that the power in the substantially DC state associated with the first machine segment is combined with the power in the substantially DC state associated with the second machine segment to produce a combined DC power such that the combined DC power is transferred between the plurality of machine segments and an external electrical circuit.

11. The system of claim 9, wherein the electrical terminal from the plurality of electrical terminals of the first machine segment and the electrical terminal from the plurality of electrical terminals of the second machine segment electrically couple the first machine segment in parallel with the second machine segment.

12. The system of claim 10, wherein the electrical terminal from the plurality of electrical terminals of the first machine segment is a first electrical terminal from the plurality of electrical terminals of the first machine segment,
the first electrical terminal of the first machine segment and the electrical terminal of the second machine segment electrically couple the first machine segment in parallel with the second machine segment,
an electrical terminal from the plurality of electrical terminals of a third machine segment from the plurality of machine segments and a second electrical terminal from the plurality of electrical terminals of the first machine segment electrically couple the first machine segment in series with the third machine segment.

13. The system of claim 10, wherein the combined DC power is a first combined DC power and the external electrical circuit is a first external electrical circuit,
an electrical terminal from the plurality of electrical terminals of a third machine segment from the plurality of machine segments configured to be electrically connected to an electrical terminal from the plurality of electrical terminals of a fourth machine segment from the plurality of machine segments such that the power in the substantially DC state associated with the third machine segment is combined with the power in the substantially DC state associated with the fourth machine segment to produce a second combined DC power different from the first combined DC power such that the second combined DC power is transferred between the plurality of machine segments and a second external electrical circuit different from the first electrical circuit.

14. The system of claim 10, wherein the first machine segment from the plurality of machine segments is configured to be associated with a first level of power in the substantially DC electrical state for a time period,
the second machine segment from the plurality of machine segments is configured to be associated with a second level of power in the substantially DC electrical state for the time period, the second level of power being different than the first level of power.

15. The system of claim 10, wherein the plurality of machine segments is configured to operate in a first mode during a first time period, the plurality of machine segments configured to operate in a second mode during a second time period different than the first time period,
when the plurality of machine segments is in the first mode:
the plurality of machine segments is configured to receive the combined DC power from the external electrical circuit, the plurality of machine segments is configured to convert the combined DC power received from the external electrical circuit to the power in the substantially mechanical state, such that the plurality of machine segments collectively operate as a motor,
when the system is in the second mode:
the plurality of machine segments is configured to receive the power in the substantially mechanical state from the moving body, the plurality of machine segments is configured to convert the power in the substantially mechanical state from the shared moving body to the combined DC power, such that the plurality of machine segments collectively operate as a generator.

16. The system of claim 13, wherein
the plurality of machine segments configured to have a first level of power associated with the first combined DC power for a time period,
the plurality of machine segments configured to have a second level of power associated with the second combined DC power for the time period, the second level of power being different than the first level of power.

17. The system of claim 10, further comprising a controller operatively coupled to at least one machine segment from the plurality of machine segments, the controller configured to at least partially control the at least one machine segment from the plurality of machine segments in response to at least one of an instruction programmed in the controller, a signal or instruction sent to the controller, a signal or instruction detected in at least one machine segment from the plurality of machine segments, or a signal or instruction delivered to at least one machine segment from the plurality of machine segments.

18. The system of claim 10, further comprising a protection element electrically connected to at least one of the electrical terminal from the plurality of electrical terminals of the first machine segment or the electrical terminal from the plurality of electrical terminals of the second machine segment, the protection element configured to reduce at least one of a voltage or a current in at least one machine segment from the plurality of machine segments in response to a fault condition.

19. A system, comprising:
a plurality of machine segments, each machine segment from the plurality of machine segments configured to share a moving body of an electromagnetic machine,
each machine segment from the plurality of machine segments configured to be associated with a portion of a total power of the electromagnetic machine,
each machine segment from the plurality of machine segments having a first portion including an electrically conductive machine winding, the electrically conductive machine winding of the first portion of each machine segment from the plurality of machine segments and the moving body collectively configured to convert power between a substantially mechanical state and a substantially alternating current (AC) electrical state,
each machine segment from the plurality of machine segments having a second portion including a power converter electrically coupled to the electrically conductive machine winding of the first portion of that machine segment, the power converter of each machine segment from the plurality of machine segments configured to convert power between the substantially AC electrical state and a substantially direct current (DC) electrical state,
the second portion of a first machine segment from the plurality of machine segments being electrically coupled in series with the second portion of a second machine segment from the plurality of machine segments.

20. The system of claim 19, wherein the first machine segment from the plurality of machine segments has a first level of electrical isolation, the first level of electrical isolation being associated with at least a portion of components forming the first machine segment, the first machine segment having a second level of electrical isolation, the second level of electrical isolation being associated with a boundary of the first machine segment, the first level of electrical isolation being different than the second level of electrical isolation.
